(19) United States
(12) Patent Application Publication
(10) Pub. No.: US 2012/0062848 A1
(43) Pub. Date: Mar. 15, 2012

(54) PROJECTION TYPE DISPLAY APPARATUS

(75) Inventors: Atsushi Koyanagi, Fukushima (JP); Masahiro Murakawa, Fukushima (JP)

(73) Assignee: ASAHI GLASS COMPANY, LIMITED, Chiyoda-ku (JP)

(21) Appl. No.: 13/227,793

(22) Filed: Sep. 8, 2011

(30) Foreign Application Priority Data
Sep. 8, 2010 (JP) 2010-200971

(51) Int. Cl. G02B 27/48; G03B 21/14

(52) U.S. Cl. 353/20

(57) ABSTRACT

A projection type display apparatus includes: a light source section including at least one light source for emitting coherent light; an image light generating section for modulating the light emitted from the light source section so as to generate image light; a projection section for projecting the image light; and a depolarization element for transmitting the incident light in a state that a polarization state of at least a part of the light is changed, the depolarization being provided on an optical path of the light emitted from the light source section, wherein a plurality of unit regions having a particular shape are aligned in the depolarization element.

### BACKGROUND

1. Field of the Invention

The present invention relates to a projection type display apparatus and, in particular, to a projection type display apparatus employing a light source having coherence.

2. Description of the Related Art

In a projection type display apparatus such as a data projector or a back projection type television receiver for displaying a projected image on a screen, an ultra-high pressure (UHP) mercury lamp has been employed as a light source in the prior art. However, a laser is proposed from the aspects of improved monochromaticity and enhanced lifetime of the light source.

Further, in the UHP lamp, from its nature, a broad spectrum is generated in a wavelength band around 645 nm which is a wavelength of red. Thus, a light source of combined type is also proposed that employs a laser as a red light source and a UHP lamp as a light source for blue and green wavelength bands. However, in such a projection type display apparatus employing a laser as a light source, the coherence of the laser light causes a speckle noise of granular pattern in the projected image. This causes a problem of degradation of image quality of the projected image.

Thus, a projection type display apparatus has been reported in which a phase modulation element serving as phase modulation means composed of a liquid crystal or a polymer liquid crystal is arranged on the optical path of a laser light serving as a light source (International Publication No. 2008/047800). Then, in the phase modulation element, the alignment direction of slow axis and the retardation value are distributed such that any one or both of these vary in a plane perpendicular to the optical axis of the laser light. Further, examples are shown that the alignment direction of the slow axis is distributed in the radial direction or in the circumference direction about the optical axis over the entire incident plane of the laser light.

Here, in International Publication No. 2008/047800, the alignment direction of slow axis and the retardation value are distributed and vary smoothly over the entirety of a plane perpendicular to the optical axis of the incident laser light. Thus, when the distribution is considered within a small part of the region of light incident onto the phase modulation means, variation in the alignment direction of slow axis or the retardation value is small. This has caused a problem that the speckle noise is difficult to be reduced remarkably in such a small part.

### SUMMARY

The present invention has been devised in order to resolve such a problem in the prior art. Its object is to provide a projection type display apparatus in which when a light source having coherence is employed, a speckle noise is stably reduced remarkably so that reliability is achieved.

According to an aspect of the invention, there is provided a projection type display apparatus including: a light source section including at least one light source configured to emit coherent light; an image light generating section configured to modulate the light emitted from the light source section so as to generate image light; a projection section configured to project the image light; and a depolarization element configured to transmit the incident light in a state that a polarization state of at least a part of the light is changed, the depolarization element being provided on an optical path of the light emitted from the light source section, wherein a plurality of unit regions having a particular shape are aligned in the depolarization element.

In the projection type display apparatus, a composition of a plurality of Stokes vectors corresponds to a plurality of polarization states of the light transmitted through the unit region may be approximately 0.

In the projection type display apparatus, the unit region may be composed of a first region and a second region, and light transmitted through the first region and has a first polarization direction and light transmitted through the second region and has a second polarization direction may be orthogonal to each other.

In the projection type display apparatus, the first region and the second region may be regions having a longitudinal direction and a lateral direction and elongated in one direction, and may be aligned in the lateral direction, and the unit regions may be aligned in the lateral direction.

In the projection type display apparatus, the unit region may be constructed such that two of the first regions and two of the second regions are arranged in a checkered pattern, and a plurality of the unit regions may be aligned in two dimensions.

In the projection type display apparatus, the light having the first polarization direction and the light having the second polarization direction may be linearly polarized.

In the projection type display apparatus, the light having the first polarization direction and the light having the second polarization direction may be circularly polarized.

In the projection type display apparatus, the unit region may include a first region, a second region, and a third region, and each of the first region, the second region, and the third region may transmit light of a polarization state different from each other.

In the projection type display apparatus, the first region, the second region, and the third region may be regions having a longitudinal direction and a lateral direction and elongated in one direction, and may be aligned in the lateral direction in this order, and the unit regions may be aligned in the lateral direction.

In the projection type display apparatus, the unit region may be constructed from one or two combinations of the first region, the second region, and the third region aligned in two dimensions including mutually adjacent parts, and a plurality of the unit regions may be aligned in two dimensions.

In the projection type display apparatus, the unit region may include a first region, a second region, a third region, and a fourth region, and each of the first region, the second region, the third region, and the fourth region may transmit light of a polarization state different from each other.

In the projection type display apparatus, the first region, the second region, the third region, and the fourth region may be square regions and aligned in two dimensions, and a plurality of the unit regions may be aligned in two dimensions.

In the projection type display apparatus, the unit region may be constructed from N regions (N is an integer ≧5), and each of the N regions may transmit light of a polarization state different from each other.

In the projection type display apparatus, the N regions may be regions having a longitudinal direction and a lateral direction and elongated in one direction, and may be aligned in the lateral direction, and the unit regions may be aligned in the lateral direction.

In the projection type display apparatus, the depolarization element may have a birefringent material layer composed of a birefringent material on a transparent substrate.

In the projection type display apparatus, the depolarization element may have a birefringent material layer on a transparent substrate and in the unit region, the optic axis of the birefringent material layer may extend radially from the center of the unit region, and a plurality of the unit regions may be aligned in two dimensions.

In the projection type display apparatus, the depolarization element may have a birefringent material layer on a transparent substrate and in the unit region, the optic axis of the birefringent material layer may extend concentrically about the center of the unit region, and a plurality of the unit regions may be aligned in two dimensions.

In the projection type display apparatus, the depolarization element may have a birefringent material layer on the transparent substrate, the unit region may be a region having a longitudinal direction and a lateral direction and elongated in one direction, and the optic axis of the birefringent material layer may have a shape of waves whose traveling direction is in the lateral direction, and the unit regions may be aligned in the lateral direction.

In the projection type display apparatus, the maximum inclination of the optic axis forming the wave shape may be 45 degrees or greater relative to the traveling direction.

In the projection type display apparatus, the inclination angle of the optic axis forming the wave shape may vary uniformly relative to the traveling direction.

In the projection type display apparatus, the birefringent material layer may have a function of a ½-wave plate so as to impart a phase difference corresponding to this to the incident light.

In the projection type display apparatus, the birefringent material layer may include a birefringent material.

In the projection type display apparatus, the light incident onto the depolarization element is linearly polarized.

The projection type display apparatus may further include a rocking control section configured to oscillate the depolarization element.

The present invention realizes an effect that in a projection type display apparatus employing a light source having coherence, generation of a speckle noise is stably reduced remarkably over the entirety of the projection image.

### BRIEF DESCRIPTION OF THE DRAWINGS

The present invention will become more fully understood from the detailed description given hereinbelow and the accompanying drawing which is given by way of illustration only, and thus is not limitative of the present invention and wherein:

FIG. 1A is a conceptual configuration diagram of a projection type display apparatus;

FIG. 1B is a conceptual configuration diagram of a projection type display apparatus having a rocking control section;

FIG. 2A is a view of a depolarization element employed in a projection type display apparatus of a first embodiment;

FIG. 2B is a schematic diagram showing a configuration of a unit region and polarization states of transmitted light;

FIG. 2C is a schematic diagram showing a configuration of a unit region and other polarization states of transmitted light;

FIG. 3 shows a Poincare sphere indicating the polarization state at each position;

FIG. 4A shows Example 1 of a schematic sectional view of a unit region of the first embodiment;

FIG. 4B shows Example 2 of a schematic sectional view of a unit region of the first embodiment;

FIG. 5A shows Example 3 of a schematic sectional view of a unit region of the first embodiment;

FIG. 5B shows Example 4 of a schematic sectional view of a unit region of the first embodiment;

FIG. 5C shows Example 5 of a schematic sectional view of a unit region of the first embodiment.

FIG. 6A is a view of a depolarization element employed in a projection type display apparatus of a second embodiment;

FIG. 6B is a schematic diagram showing a configuration of a unit region and polarization states of transmitted light;

FIG. 6C is a schematic diagram showing a configuration of a unit region and other polarization states of transmitted light;

FIG. 7A shows Example 1 of a schematic sectional view of a unit region of the second embodiment;

FIG. 7B shows Example 2 of a schematic sectional view of a unit region of the second embodiment;

FIG. 8A is a view of a depolarization element employed in a projection type display apparatus of a third embodiment;

FIG. 8B is a view of another depolarization element employed in a projection type display apparatus of the third embodiment;

FIG. 8C is a schematic diagram showing a configuration of a unit region and polarization states of transmitted light;

FIG. 8D is a schematic diagram showing a configuration of a unit region and other polarization states of transmitted light;

FIG. 9A is a schematic sectional view of a unit region (a third embodiment);

FIG. 9B is another schematic sectional view of a unit region of the third embodiment;

FIG. 10A is a view of a depolarization element employed in a projection type display apparatus of a fourth embodiment;

FIG. 10B is a schematic diagram showing a configuration of a unit region and polarization states of transmitted light;

FIG. 10C is a schematic diagram showing a configuration of a unit region and other polarization states of transmitted light;

FIG. 11A is a schematic sectional view of a first part of a unit region of the fourth embodiment;

FIG. 11B is a schematic sectional view of a second part of a unit region;

FIG. 11C is a schematic sectional view of a first part of another unit region of the fourth embodiment;

FIG. 11D is a schematic sectional view of a second part of another unit region of the fourth embodiment;

FIG. 12A is a view of a depolarization element employed in a projection type display apparatus of a fifth embodiment;

FIG. 12B is a schematic diagram showing a configuration of a unit region and polarization states of transmitted light;

FIG. 12C is a schematic diagram showing a configuration of a unit region and other polarization states of transmitted light;

FIG. 13A is a schematic sectional view of a unit region of the fifth embodiment;

FIG. 13B is another schematic sectional view of a unit region of the fifth embodiment;

FIG. 14A is a view of a depolarization element employed in a projection type display apparatus of a sixth embodiment;

FIG. 14B is a schematic diagram showing a configuration of a unit region;

FIG. 14C is a schematic diagram showing a configuration of another unit region;

FIG. 14D is a schematic sectional view of a depolarization element of the sixth embodiment;

FIG. 15A is a view of a depolarization element employed in a projection type display apparatus of the seventh embodiment; and

FIG. 15B is a view of another depolarization element employed in a projection type display apparatus of the seventh embodiment.

### DETAILED DESCRIPTION OF THE INVENTION

### Embodiment of Projection Type Display Apparatus

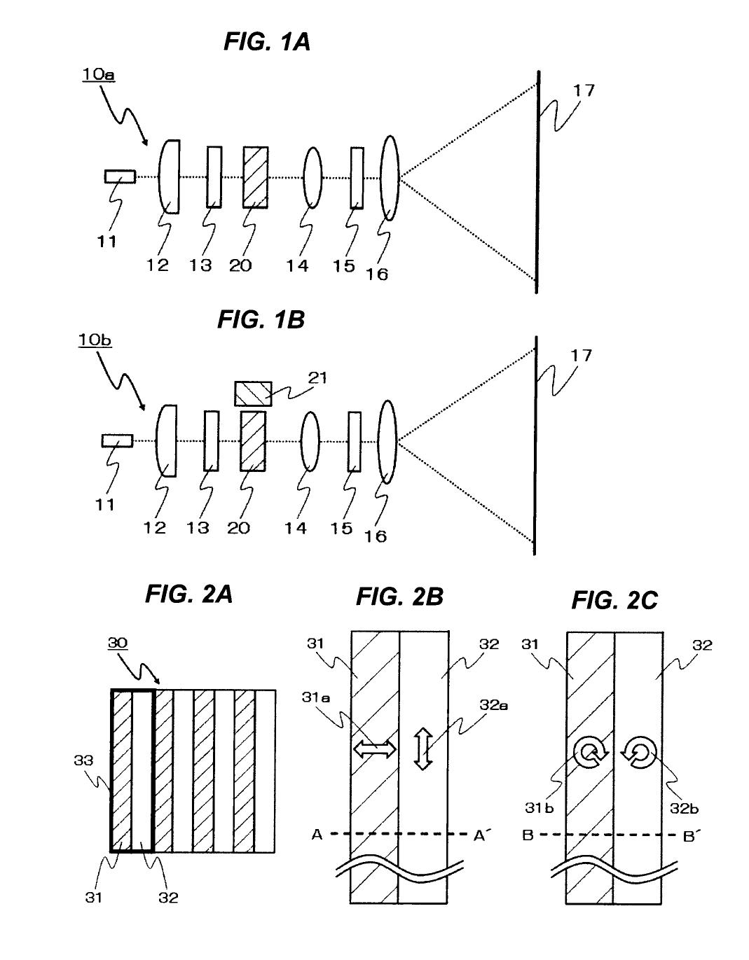

FIGS. 1A and 1B are schematic diagrams each showing a configuration of a projection type display apparatus according to the present embodiment. Light emitted from at least one laser 11 such as a semiconductor laser and a solid-state laser serving as a light source section for generating coherent light which is light-emitting means is collimated into the form of an approximately parallel light beam by a collimator lens 12, and then passes through a polarizer 13. As the laser 11, for example, a semiconductor laser emits linearly polarized light. Then, in some cases, variation or time-dependent fluctuation is caused in the polarization direction by manufacturing variation, an operating environment temperature change, and the like. The polarizer 13 is employed for maintaining the polarization state of the light to be constant, but may be omitted. The light having passed through the polarizer 13 then enters a depolarization element 20 of each configuration described later, so that light of a different polarization state is transmitted in a state that spatial light coherence is averaged out. The scattered light transmitted through the depolarization element 20 is condensed by a condenser lens 14 into a spatial light modulator 15 serving as an image light generating section. Further, the light emitted from the laser 11 may be scattered through a light guide such as an optical fiber. In this case, the projection type display apparatus 10a or 10b may have a configuration shown in FIG. 1A or 1B. Alternatively, a configuration may be employed that the collimator lens 12 and the polarizer 13 are not included.

The light having passed through the depolarization element 20 and the condenser lens 14 is homogenized and projected onto the spatial light modulator 15. For example, when the condenser lens 14 is composed of a condenser lens having a large numerical aperture, efficient light acquisition is achieved and hence light utilization efficiency is improved. Typically, the spatial light modulator 15 may be composed of a transmission type liquid crystal panel. Alternatively, a reflection type liquid crystal panel, a digital micro mirror device (DMD), or the like may be employed. When a transmission type liquid crystal panel or a reflection type liquid crystal panel is employed, a polarization conversion element may be arranged between the depolarization element 20 and the spatial light modulator 15 so as to improve the light utilization efficiency. That is, when the light transmits through the polarization conversion element, the polarization state is homogenized. Thus, for example, when the light is transmitted through or reflected by an optical element having polarization dependence, the light utilization efficiency is improved.

The light beam having entered the spatial light modulator 15 as described above is modulated in accordance with the image signal, and then projected onto a screen 17 or the like through a projection lens 16. Here, the light source may have a configuration that one laser light source alone is employed, a configuration that a plurality of laser light sources for emitting light of mutually different wavelengths are arranged, or alternatively a configuration that a non-coherent light source and a laser light source are employed in combination. Further, the depolarization element 20 may be arrange on the optical path between the spatial light modulator 15 and the projection lens 16 or alternatively on the optical path between the projection lens 16 and the screen 17.

Further, the projection type display apparatus 10b shown in FIG. 1B has a rocking control section 21 for rocking the depolarization element 20. In the other points, the same configuration as the projection type display apparatus 10a shown in FIG. 1A is employed. Specifically, it is sufficient that the rocking control section 21 is capable of rocking the depolarization element 20 with a fixed period in a particular direction. Then, the rocking control section 21 has a mechanical structure constructed from a motor, a spring, a piezoelectric element, and an actuator utilizing an electromagnetic force, or the like. As for the direction of rocking of the depolarization element 20, for example, the depolarization element 20 may be oscillated repeatedly in a plane perpendicular to the optical axis in one dimension, rotated about the optical axis, or alternatively oscillated such as to form a circle in a plane perpendicular to the optical axis. Further, the rocking control section 21 may have a mechanism for oscillating the depolarization element 20 in the optical axis direction or alternatively in three dimensions. Further, it is preferable that the period of oscillation corresponds to 30 Hz or higher at which human eyes cannot follow the oscillation. Further, 50 Hz or higher is more preferable. Here, the detailed configuration of the depolarization element 20 and the relation with the direction of rocking of the depolarization element 20 are described later.

(First Embodiment of Depolarization Element Employed in Projection Type Display Apparatus)

Next, the depolarization element employed in the projection type display apparatus according to the present invention is described below. Here, each depolarization element described below may be arranged, for example, at the position of the depolarization element 20 of the projection type display apparatus 10a or 10b, at a position between the spatial light modulator 15 and the projection lens 16, or alternatively at a position between the projection lens 16 and the screen 17. FIG. 2A is a schematic plan view of a depolarization element 30 according to the present embodiment. In the depolarization element 30, unit regions 33 each composed of a first region 31 and a second region 32 are arranged successively in a particular direction. Specifically, each of the first region 31 and the second region 32 has a rectangular shape, and a plurality of the unit regions 33 are arranged in the lateral direction of the rectangle. Here, it is preferable that the number expressing the plurality is 5 to 50. If a number smaller than 5 is adopted, the effect of resolving the speckle noise is not obtained satisfactorily. In contrast, if a number greater than 50 is adopted, diffraction generated on the boundaries between of the unit regions 33 causes a loss in the intensity of the light and hence a high light-utilization efficiency is not obtained.

Then, the light transmitted through the first region 31 has a uniform polarization state, and the light transmitted through the second region 32 has a uniform polarization state. However, the polarization states of the transmitted light are different between these regions. Here, it is sufficient that the unit region 33 has a shape having a longitudinal direction and a lateral direction and elongated in one direction. That is, the unit region 33 may not be a rectangle and may be, for example, a parallelogram, a trapezoid, other polygons, and a shape having a curved surface. The unit regions are arranged such that a plurality of these are aligned in lateral direction. Further, it is desirable that the areas of the first region 31 and the second region 32 are approximately the same as each other so that the intensities of the transmitted light in the individual polarization states become approximately the same as each other. Here, in the Stokes vector of the light transmitted through each region, the intensity S₀ of the light has been omitted. However, the S₀ is proportional to the area of the region of transmission. Thus, when the area of each region is not identical, the intensity S₀ of the light may be taken into consideration. In this case, the area of each region may be not identical. The following description is given with an assumption that the area of each region is approximately identical.

FIGS. 2B and 2C are schematic plan views showing the unit region 33 alone in an expanded manner. Specifically, these views show exemplary combinations of the polarization states of the light transmitted through the first region 31 and the second region 32. Here, the polarization direction of the light transmitted through the first region 31 is referred to as a first polarization direction, and the polarization direction of the light transmitted through the second region 32 is referred to as a second polarization direction. Then, it is preferable that the first polarization direction and the second polarization direction are orthogonal to each other. Specifically, FIG. 2B shows a situation of first linearly polarized light 31a in a first polarization direction and second linearly polarized light 32a in a second polarization direction perpendicular to the first polarization direction. Further, employable situations are not limited to such a combination of linearly polarized light beams and may be, as shown in FIG. 2C, a combination of first circularly polarized light 31b in a first polarization direction and second circularly polarized light 32b in a second polarization direction which is orthogonal to the first circularly polarized light 31b, that is, has a reverse rotation direction relative to the first circularly polarized light 31b.

Further, the combination of the polarization state of the light transmitted through the first region 31 and the polarization state of the light transmitted through the second region 32 may be discussed as follows by using a Stokes parameter S. First, a Stokes parameter S is usually expressed by a four-dimensional vector (S₀, S₁, S₂, S₃). Then, the traveling direction of the light is defined as the Z-axis direction, and then the X-Y plane perpendicular to the Z-axis direction is defined. S₀ denotes the intensity of the light. S₁ denotes the intensity of the electric field oscillating, for example, in the direction of 0° relative to the X-axis direction. S₂ denotes the intensity of the electric field oscillating in the direction of 45° relative to the X-axis direction. S₃ denotes the intensity of circular polarization of the light. The following description is given with a simplification that the intensity S₀ of the light is omitted and hence the Stokes parameter S is described as a three-dimensional vector (S₁, S₂, S₃).

Here, the polarization state of the light transmitted through the first region 31 is expressed by using a Stokes parameter S(1) as S(1)=(S₁₁, S₂₁, S₃₁). The polarization state of the light transmitted through the second region 32 is expressed by using a Stokes parameter S(2) as S(2)=(S₁₂, S₂₂, S₃₂). Then, when the depolarization element 30 has the combination of polarization states shown in FIG. 2B, the first linearly polarized light 31a is expressed as S(1)=(1, 0, 0) and the second linearly polarized light 32a is expressed as S(2)=(−1, 0, 0). Further, when the depolarization element 30 has the combination of polarization states shown in FIG. 2C, the first circularly polarized light 31b is expressed as S(1)=(0, 0, 1) and the second circularly polarized light 32b is expressed as S(2)=(0, 0, −1).

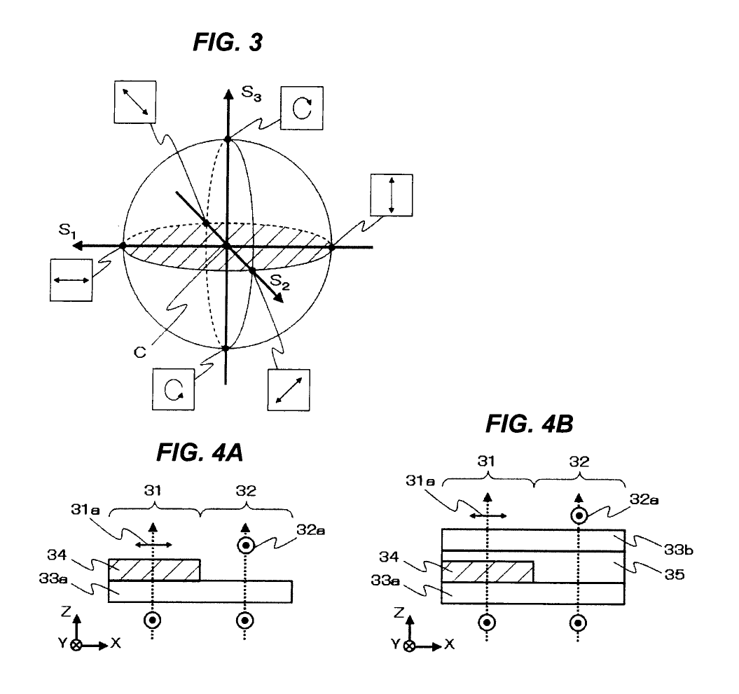

Further, FIG. 3 shows a Poincare sphere expressing the polarization state. The relation between the polarization state of the light transmitted through the first region 31 and the polarization state of the light transmitted through the second region 32 is discussed by using the Poincare sphere. Here, a vector extending from the center point C of the Poincare sphere to the position of each Stokes parameter is adopted as the Stokes vector. At that time, in the Poincare sphere, first, the Stokes vector of the first linearly polarized light 31a is the positive direction on the S₁-axis. On the other hand, the Stokes vector of the second linearly polarized light 32a is in the negative direction on the S₁-axis. Further, the Stokes vector of the first circularly polarized light 31b is in the positive direction on the S₃-axis. On the other hand, the Stokes vector of the second circularly polarized light 32b is in the negative direction on the S₃-axis.

Here, the relation is considered between the Stokes vector of the light transmitted through the first region 31 and the Stokes vector of the light transmitted through the second region 32. Then, in each case, zero is obtained when these vectors are composed In this example, the light transmitted through the first region 31 and the light transmitted through the second region 32 are assumed to be a combination of linearly polarized light beams or alternatively a combination of circularly polarized light beams. However, employable combinations are not limited to these and may be, for example, a combination of elliptically polarized light beams as long as these Stokes vectors expressing the polarization states of the light are in a relation of canceling out with each other. Here, in other depolarization elements described later, the relation between the polarization states of the light transmitted through the unit region can be described by using the Poincare sphere.

Next, detailed configurations of the unit region 33 for transmitting the light of individual polarization states shown in FIGS. 2B and 2C are described below. First, FIGS. 4A and 4B show examples of schematic sectional views taken along line A-A′ in FIG. 2B. The depolarization element 30 has a birefringent material layer 34 composed of a birefringent material on a transparent substrate 33a. Then, in FIGS. 4A and 4B, the birefringent material layer 34 is formed only in the first region 31. Further, as shown in FIG. 4B, for example, a configuration may be employed that a filling material layer 35 composed of an isotropic transparent material for filling in and flattening the unevenness formed by the birefringent material layer 34 is provided and then the transparent substrate 33b is arranged opposite to the transparent substrate 33a so that these components are integrated together.

Further, the transparent substrates 33a and 33b may be composed of a material of diverse kind such as a resin plate and a resin film as long as it is transparent to incident light. In particular, an optically isotropic material such as glass and quartz does not impart an influence of birefringence to the transmitted light and hence is preferable. Further, for example, when the transparent substrates 33a and 33b have an antireflection film composed of a multilayer film in the interface with air, a light reflection loss caused by Fresnel reflection is reduced. Further, the birefringent material may be composed of a birefringence crystal such as quartz and LiNbO₃, a birefringence film fabricated by expanding an organic film such as a polycarbonate film, or alternatively a polymer liquid crystal fabricated by a method that liquid crystal monomers having birefringence are aligned in one direction or twist-aligned and then polymerized and solidified.

Further, in addition to these, the birefringent material layer may employ: structural birefringence generated by a lattice shape constructed from fine concaves and convexes or alternatively a photonic crystal formed by stacking an optical multilayer onto a lattice shape constructed from concaves and convexes. Here, when the structural birefringence, the photonic crystal, or the like is employed, the optic axis corresponds to the longitudinal direction of the lattice shape constructed from fine concaves and convexes and to a direction perpendicular to the longitudinal direction. Further, an alignment film (not shown) may be provided between the transparent substrate 33a and the birefringent material layer 34. Also employable are: an alignment film fabricated by a rubbing process; an optical alignment film whose alignment direction can be controlled by light like ultraviolet light; an alignment film formed by oblique vapor deposition of SiO₂ or the like; and an alignment film whose alignment direction is controlled by a fine groove structure. Here, also in the embodiments of subsequent depolarization elements described below, the above-mentioned materials for the transparent substrate and the birefringent material may be employed unless otherwise mentioned.

Next, a detailed configuration of the birefringent material layer 34 is described below. First, the direction of the light incident onto and transmitted through the depolarization element 30 is defined as the Z-direction. Then, the transparent substrate 33a surface is defined as the X-Y plane. Further, it is assumed that the direction of the optic axis of the birefringent material constituting the birefringent material layer 34 is uniform in the direction of 45 degrees relative to the X-axis in the X-Y plane. Here, the optic axis indicates the slow axis or the fast axis. Here, the ordinary light refractive index of the birefringent material to the light having an incident wavelength λ, is denoted by n₀, and the extraordinary light refractive index is denoted by nₑ. Then, it is preferable that the thickness d of the birefringent material layer 34 is set to be a value approximately equal to (2m−1)λ/(2×|nₑ−n₀|) with a natural number m so that the birefringent material layer 34 serves as an ½-wave plate. In particular, when m=1 is adopted, a small value for d is achieved and even when the wavelength λ, fluctuates outside a predetermined range, the polarization state does not largely fluctuate from a predetermined state and hence wavelength dependence of the phase difference is stabilized. Thus, this adoption is preferable. In the following description, |nₑ−n₀| is referred to as a refractive index anisotropy Δn.

Then, when the incident light is linearly polarized in the Y-direction, the light incident onto the first region 31 is transmitted through the birefringent material layer 34 having the function of a ½-wave plate, and thereby converted into linearly polarized light in the X-direction. On the other hand, the light incident onto the second region 32 is transmitted without a change in the polarization state, and hence remains in the intact form of the linearly polarized light in the Y-direction. By virtue of this, the light incident onto the depolarization element 30 is transmitted in such polarization states that linearly polarized light beams whose polarization states are orthogonal to each other are arranged alternately. This reduces a speckle noise. Here, the employable polarization states of the incident light are not limited to this, and include linearly polarized light in a direction other than the Y-direction, elliptically polarized light, and circularly polarized light. Regardless of the kind of polarization state of the incident light, it is sufficient that the composition of the Stokes vectors expressing the polarization states of the transmitted light becomes approximately zero. Here, the description of the following embodiments is given for a case that the polarization state of the incident light is linearly polarized light in the Y-direction.

Further, it has been assumed that the second region 32 does not have a birefringent material layer. However, employable configurations are not limited to this. For example, in a case that the slow axis is not twisted, even when both of the first region 31 and the second region 32 have a birefringent material layer such that the thickness of the first region 31 is λ/(2×Δn) and the thickness of the second region 32 is λ/Δn, the polarization states of the light transmitted through the individual regions satisfy the relation between the first linearly polarized light 31a and the second linearly polarized light 32a as shown in FIG. 2B. Further, employable configurations are not limited to this configuration that the birefringent material layer 34 of the first region 31 has the function of a ½-wave plate. That is, the slow axis may be aligned in a twisted manner in the thickness direction by 90 degrees about the optical axis direction so that the function of a polarization rotating element may be implemented.

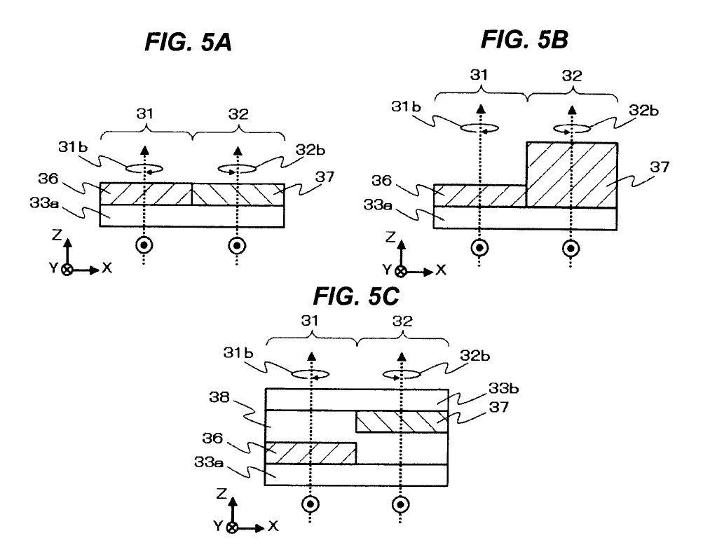

Next, a detailed configuration of the depolarization element 30 that satisfies the relation of the polarization states shown in FIG. 2C is described below. First, FIGS. 5A, 5B, and 5C show examples of schematic sectional views taken along line B-B′ in FIG. 2C. The depolarization element 30 has a birefringent material layer 36 composed of a birefringent material in the first region 31 and a birefringent material layer 37 composed of a birefringent material in the second region 32. Here, the X-, Y-, and Z-directions are defined to be the same as those in FIGS. 4A and 4B.

The configuration shown in FIG. 5A is described first. The depolarization element 30 according to the configuration shown in FIG. 5A has a birefringent material layer 36 in the first region 31 and a birefringent material layer 37 in the second region 32. The birefringent materials constituting these layers are composed of an identical material and have the same thickness. Then, in the X-Y plane, for example, when the direction of the slow axis of the birefringent material layer 36 is uniform in the direction of 45 degrees relative to the X-axis, it is assumed that the direction of the slow axis of the birefringent material layer 37 is uniform in the direction of −45 degrees relative to the X-axis. At that time, it is preferable that the thickness d of the birefringent material layers 36 and 37 is set to be a value approximately equal to (4m−3)λ/(4×Δn) where m is a natural number, so that the birefringent material layers 36 and 37 serve as ¼-wave plates. Further, for example, a configuration may be employed that a filling material layer and a transparent substrate (not shown) are provided on the birefringent material layers 36 and 37 so that these components are integrated together. Further, m=1 is preferable by a reason similar to that described above.

Further, the depolarization element 30 according to the configuration shown in FIG. 5B has a birefringent material layer 36 in the first region 31 and a birefringent material layer 37 in the second region 32. These layers are composed of the same birefringent material. Further, in these layers, the direction of the slow axis is identical in the direction of 45 degrees relative to the X-axis in the X-Y plane. However, these layers have different thicknesses from each other. Specifically, when m and p are natural numbers, it is preferable that the thickness d1 of the birefringent material layer 36 is set to be a value approximately equal to (4m−3)λ/(4×Δn) and the thickness d2 of the birefringent material layer 37 is set to be a value approximately equal to (4p−1)λ/(4×Δn) so that the birefringent material layers 36 and 37 serve as ¼-wave plates. Further, for example, a configuration may be employed that a filling material layer (not shown) for filling in and flattening is provided on the birefringent material layers 36 and 37 and then these components are integrated together with the transparent substrate. Further, in this case, m=1 and p=1 are preferable by a reason similar to that described above.

Further, the depolarization element 30 according to the configuration shown in FIG. 5C has a birefringent material layer 36 only in the first region 31 on a transparent substrate 33a and a birefringent material layer 37 only in the second region 32 on a transparent substrate 33b. Then, unevenness formed by the birefringent material layer 36 and the birefringent material layer 37 is filled in and flattened by a filling material layer 38 so that these components are integrated together. The birefringent materials constituting these layers are composed of an identical material and have the same thickness. Then, in the X-Y plane, for example, when the direction of the slow axis of the birefringent material layer 36 is uniform in the direction of 45 degrees relative to the X-axis, it is assumed that the direction of the slow axis of the birefringent material layer 37 is uniform in the direction of −45 degrees relative to the X-axis. At that time, it is preferable that the thickness d of the birefringent material layers 36 and 37 is set to be a value approximately equal to (4m−3)λ/(4×Δn) where m is a natural number, so that the birefringent material layers 36 and 37 serve as ¼-wave plates. Further, in this case, m=1 is preferable by a reason similar to that described above.

Then, when the light incident onto the depolarization element 30 according to the configuration shown in FIGS. 5A, 5B, and 5C is linearly polarized light in the Y-direction, the light incident onto the first region 31 is transmitted through the birefringent material layer 36 having the function of a ¼-wave plate, and thereby converted into first circularly polarized light 31b which is, for example, right-handed circularly polarized light 31b. On the other hand, the light incident onto the second region 32 is transmitted through the birefringent material layer 37 having the function of a ¼-wave plate, and thereby converted into second circularly polarized light 32b which is, in this case, left-handed circularly polarized light 32b. By virtue of this, the light incident onto the depolarization element 30 is transmitted in such polarization states that polarized light beams whose polarizations are orthogonal to each other, in this case, right-handed circularly polarized light beams and left-handed circularly polarized light beams, are aligned alternately. This reduces a speckle noise.

Further, the depolarization element 30 according to the present embodiment has been described for exemplary cases of linearly polarized light and circularly polarized light with assuming that it is preferable that the first polarization direction and the second polarization direction of the transmitted light are orthogonal to each other. However, employable configurations are not limited to these. In addition to these, elliptically polarized light whose first polarization direction and second polarization direction are orthogonal to each other may be employed as long as the two kinds of polarization states of the light transmitted through the unit region 33 are in a relation that the Stokes vectors cancel out with each other in the Poincare sphere shown in FIG. 3 as described above. In this case, it is preferable that the thicknesses of the birefringent material layers are adjusted so that the retardation values each expressed by the product between the thickness and the refractive index anisotropy Δn are adjusted.

Further, when the depolarization element 30 according to the present embodiment is employed as the depolarization element 20 of the projection type display apparatus 10b, it is sufficient that the rocking control section 21 oscillates in a direction different from the longitudinal direction of the unit region 33 and, in particular, it is preferable to oscillate in a direction perpendicular to the longitudinal direction. As such, when the rocking control section 21 performs oscillation control, the polarization state of the transmitted light is varied not only spatially but also time-dependently. This reduces a speckle noise remarkably.

(Second Embodiment of Depolarization Element Employed in Projection Type Display Apparatus)

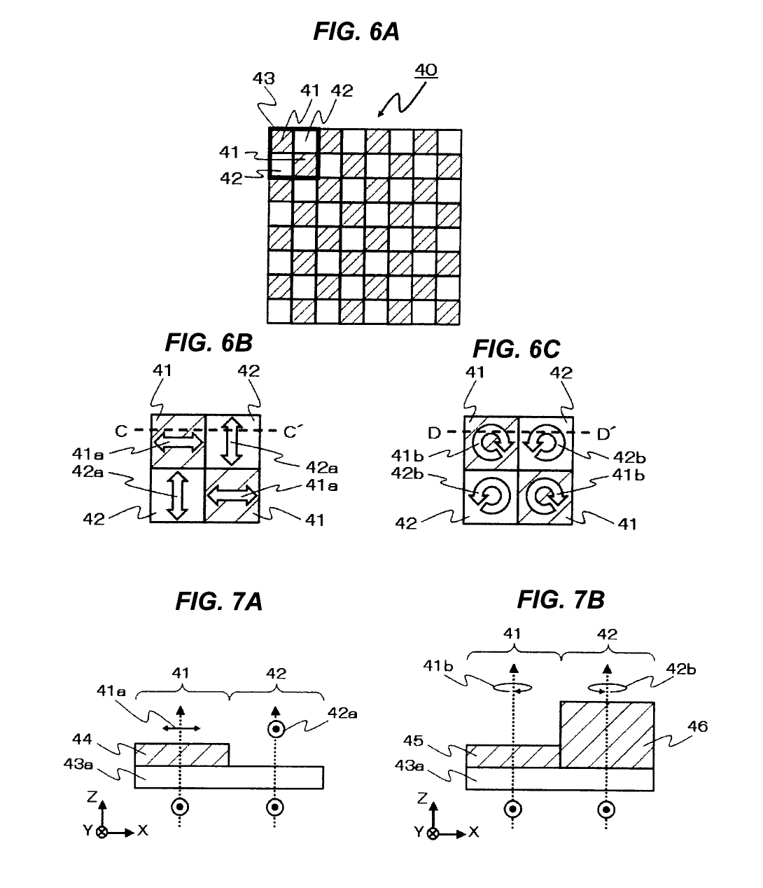

FIG. 6A is a schematic plan view of a depolarization element 40 according to the present embodiment. In the depolarization element 40, a plurality (preferably 5 to 50 by the same reason as that in the first embodiment of the depolarization element) of unit regions 43 each composed of a first region 41 and a second region 42 are arranged successively in two dimensions. Specifically, each of the first region 41 and the second region 42 is a square region. Then, the unit region 43 is a square region in which two first regions 41 and two second region 42 are arranged alternately into a so-called checkered pattern. Here, the first region 41 and the second region 42 are not limited to square regions, and may be regions each having the shape of a rectangle, a parallelogram, a polygon, or the like.

Then, the light transmitted through the first region 41 has a uniform polarization state, and the light transmitted through the second region 42 has a uniform polarization state. However, the polarization states of the transmitted light are different between these regions. Further, it is desirable that the areas of the first region 41 and the second region 42 are approximately the same as each other so that the intensities of the transmitted light in the individual polarization states become approximately the same as each other. Here, in the Stokes vector of the light transmitted through each region, the intensity S₀ of the light has been omitted. However, the S₀ is proportional to the area of the region of transmission. Thus, when the area of each region is not identical, the intensity S₀ of the light may be taken into consideration. In this case, the area of each region may not be identical. The following description is given with an assumption that the area of each region is approximately identical.

FIGS. 6B and 6C are schematic plan views showing the unit region 43 alone in an expanded manner. Specifically, these views show exemplary combinations of the polarization states of the light transmitted through the first region 41 and the second region 42. Here, the polarization direction of the light transmitted through the first region 41 is referred to as a first polarization direction, and the polarization direction of the light transmitted through the second region 42 is referred to as a second polarization direction. Then, it is preferable that the first polarization direction and the second polarization direction are orthogonal to each other. Specifically, FIG. 6B shows the situation of first linearly polarized light 41a having a first polarization direction and second linearly polarized light 42a having a second polarization direction. Further, employable combinations are not limited to a combination of linearly polarized light beams and may be, as shown in FIG. 6C, a combination between first circularly polarized light 41b in a first polarization direction and second circularly polarized light 42b in a second polarization direction which is reverse rotation relative to the first circularly polarized light. Further, the combination of the polarization states of the light may be, for example, that of elliptically polarized light beams as long as they satisfy a relation that the Stokes vectors cancel out with each other in the Poincare sphere shown in FIG. 3.

Next, detailed configurations of the unit region 43 for transmitting the light of individual polarization states shown in FIGS. 6B and 6C are described below. First, FIG. 7A shows an example of a schematic sectional view taken along line C-C′ in FIG. 6B. The depolarization element 40 has a birefringent material layer 44 composed of a birefringent material on a transparent substrate 43a. Then, the birefringent material layer 44 shown in FIG. 7A is formed only in the first region 41. Further, an aliment film (not shown) may be provided between the transparent substrate 43a and the birefringent material layer 44. In the birefringent material layer 44, similarly to the birefringent material layer 34 according to the first embodiment of the depolarization element, the thickness (the retardation value) may be set to a value realizing the function of a ½-wave plate. Further, the slow axis may be aligned in a twisted manner by 90 degrees. Here, the X-, Y-, and Z-directions are defined to be the same as those shown in FIGS. 4A and 4B, also in FIG. 7B.

Further, in the depolarization element 40, in addition to the configuration shown in FIG. 7A, a filling material layer (not shown) for filling in and flattening the unevenness formed by the birefringent material layer 44 is provided. Further, a transparent substrate (not shown) may be provided opposite to the transparent substrate 43a. Further, a configuration may be employed that the depolarization element 40 has a birefringent material layer (not shown) also in the second region 42 and that the thicknesses of the birefringent material layers are adjusted such that the retardation value of the first region 41 and the retardation values of the second region 42 are different from each other. Here, in FIG. 6B, a (sectional) configuration is not shown for a part where the second region 42 and the first region 41 are arranged from the left. However, for example, this configuration may be such that in FIG. 7A, the first region 41 and the second region 42 are exchanged with each other.

Then, when the incident light is linearly polarized in the Y-direction, the light incident onto the first region 41 is transmitted through the birefringent material layer 44 and thereby converted into linearly polarized light 41a in the X-direction. On the other hand, the light incident onto the second region 42 is transmitted without a change in the polarization state, and hence remains in the intact form of the linearly polarized light 42a in the Y-direction. By virtue of this, the light incident onto the depolarization element 40 is transmitted in such polarization states that linearly polarized light beams whose polarization states are orthogonal to each other are arranged alternately in two dimensions. This reduces a speckle noise.

Further, FIG. 7B shows an example of a schematic sectional view taken along line D-D′ in FIG. 6C. The depolarization element 40 has a birefringent material layer 45 composed of a birefringent material in the first region 41 and a birefringent material layer 46 composed of a birefringent material in the second region 42. Then, for example, it is assumed that the same birefringent material is employed for constructing these components and the direction of the slow axis in the X-Y plane is also identical and uniform in the direction of 45 degrees relative to the X-axis but that their thicknesses are different from each other. Specifically, when m and p are natural numbers, it is preferable that the thickness d1 of the birefringent material layer 45 is set to be a value approximately equal to (4m−3)λ/(4×Δn) and the thickness d2 of the birefringent material layer 46 is set to be a value approximately equal to (4p−1)λ/(4×Δn) so that the birefringent material layers 45 and 46 serve as ¼-wave plates. Further, for example, a configuration may be employed that a filling material layer is filled onto the birefringent material layers 45 and 46 so that flattening is achieved and then these components are integrated together with a transparent substrate. Further, also in this case, m=1 and p=1 are preferable by a reason similar to that in the first embodiment of the depolarization element (according to FIG. 5B).

Further, similarly to FIGS. 5A and 5C of the first embodiment of the depolarization element, the depolarization element 40 may have a configuration that a birefringent material layer that is composed of the same material same as the birefringent material layer 45 and has the same thickness but a slow axis orthogonal to that of the birefringent material layer 45 is provided in the second region 42. In this case, a filling material layer and a transparent substrate opposite to this which are not shown may further be provided so that these components may be integrated together. Here, in FIG. 6C, a (sectional) configuration is not shown for a part where the second region 42 and the first region 41 are arranged from the left. However, for example, this configuration may be such that in FIG. 7B, the first region 41 and the second region 42 are exchanged with each other.

Then, when the incident light is linearly polarized in the Y-direction, the light incident onto the first region 41 is transmitted through the birefringent material layer 45 and thereby converted into right-handed circularly polarized light 41b. On the other hand, the light incident onto the second region 42 is transmitted through the birefringent material layer 46 and thereby converted into left-handed circularly polarized light 42b. By virtue of this, the light incident onto the depolarization element 40 is transmitted in such polarization states that circularly polarized light beams whose polarization states are orthogonal to each other are arranged alternately in two dimensions. This reduces a speckle noise.

Further, when the depolarization element 40 according to the present embodiment is employed as the depolarization element 20 of the projection type display apparatus 10b, it is preferable that the rocking control section 21 oscillates at least in two dimensions that intersect the optical axis. At that time, the oscillation may be controlled such that rotational oscillation is performed or its orbit forms a circle. As such, when the rocking control section 21 performs oscillation control, the polarization state of the transmitted light is varied not only spatially but also time-dependently. This reduces a speckle noise remarkably.

(Third Embodiment of Depolarization Element Employed in Projection Type Display Apparatus)

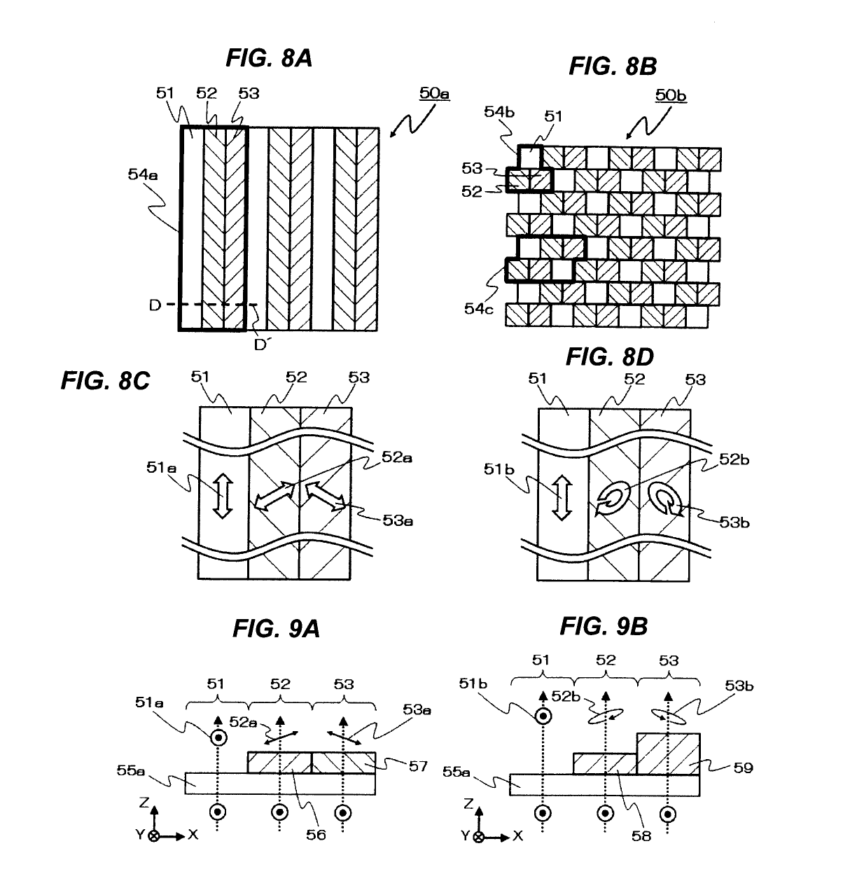

The first and the second embodiments of the depolarization element given above have been described for a case that each unit region is constructed from a first region and a second region whose polarization states of the transmitted light are different from each other. The third embodiment of the depolarization element is described for a depolarization element whose unit region is constructed from a first region, a second region, and a third region. FIGS. 8A and 8B are schematic plan views of depolarization elements 50a and 50b according to the present embodiment. Each of these is constructed from a first region 51, a second region 52, and a third region 53. Further, the light transmitted through the first region 51 has a uniform polarization state, the light transmitted through the second region 52 has a uniform polarization state, and the light transmitted through the third region 53 has a uniform polarization state. However, the polarization states of the transmitted light through these regions are different from each other.

In the depolarization element 50a shown in FIG. 8A, the first region 51, the second region 52, and the third region 53 are rectangular. Then, a plurality (preferably 5 to 50 by the same reason as that in the first embodiment of the depolarization element) of unit regions 54a are arranged successively in the lateral direction of the rectangle. Here, it is sufficient that the unit region 54a has a shape having a longitudinal direction and a lateral direction and elongated in one direction. That is, the unit region 54a may not be a rectangle and may be, for example, a parallelogram, a trapezoid, other polygons, and a shape having a curved surface. The unit regions are arranged such that a plurality of these are aligned in lateral direction.

Further, in the depolarization element 50b shown in FIG. 8B, the first region 51, the second region 52, and the third region 53 has a square shape. Then, a plurality (preferably, 5 to 50) of unit regions 54b each constructed when a long side of a rectangle composed of the second region 52 and the third region 53 aligned to each other is aligned with one side of the first region 51 are arranged in two dimensions. Further, it is preferable that the unit regions 54b are aligned such that the center of the line segment of one side of the first region 51 agrees with the position where the second region 52 and the third region 53 contact with each other. Here, employable arrangements of the unit regions 54b include an arrangement that polygons each forming the unit region 54b are arranged alternately in a manner of being rotated by 180 degrees. Further, the depolarization element 50b shown in FIG. 8B may be recognized as being constructed such that a plurality of polygonal unit regions 54c each composed of two first regions 51, two second regions 52, and two third regions 53 each having a square shape are aligned in two dimensions.

Further, in unit regions 54a, 54b, and 54c, it is preferable that the area of the first region 51, the area of the second region 52, and the area of the third region 53 are approximately identical to each other so that the intensities of the transmitted light in the individual polarization states become approximately the same as each other. However, employable configurations are not limited to this. For example, in the Stokes vector of light transmitted through each region in the unit region, the intensity S₀ of the light expresses the magnitude of the Stokes vector. Then, since S₀ is proportional to the area of the region of transmission, when the areas of the individual regions are not the same as each other, the intensity S₀ of the light may be taken into consideration. That is, when the areas of the first region 51, the second region 52, and the third region 53 are not the same as each other, the magnitudes of the Stokes vectors of the individual regions are different from each other. However, for example, when the depolarization elements 50a and 50b are constructed such that the areas and/or the polarization states of other regions of transmission are adjusted such that the Stokes vector of the light of the region having the largest area is canceled out and hence the composition of the Stokes vectors of the individual regions becomes zero, a depolarization property at the same level is achieved. Here, in other depolarization elements, even when more than three regions are included in the unit region, the intensity S₀ of the light may similarly be taken into consideration. However, the following description is given with an assumption that the areas of individual regions contained in the unit region are approximately the same as each other, unless otherwise mentioned.

FIGS. 8C and 8D are schematic plan views showing the unit region 54a alone in an expanded manner. Specifically, these views show exemplary combinations of the polarization states of the light transmitted through the first region 51, the second region 52, and the third region 53. Further, although the shape of the unit region is different, the polarization states of the transmitted light shown in FIGS. 8C and 8D may be recognized as the polarization states of the light transmitted through the individual regions in the unit region 54b or the unit region 54c of the depolarization element 50b shown in FIG. 8B.

Specifically, FIG. 80 shows the situation of first linearly polarized light 51a in a first polarization direction, second linearly polarized light 52a in a second polarization direction, and third linearly polarized light 53a having a third polarization direction. Then, the polarization directions of these three kinds of linearly polarized light are at angles of approximately 120 degrees to each other. Further, employable combinations of three light beams of mutually different polarization states are not limited to a combination of linearly polarized light beams, and may be a combination between (first) linearly polarized light 51b in a first polarization direction, first elliptically polarized light 52b, and second elliptically polarized light 53b as shown in FIG. 8D. Also in this case, it is preferable a relation is satisfied that the composition of the Stokes vectors of the light transmitted through the first region 51, the second region 52, and the third region 53 becomes approximately zero in the Poincare sphere shown in FIG. 3.

Further, FIGS. 9A and 9B show examples of schematic sectional views taken along line D-D′ in FIG. 8A. The depolarization element 50a has, on a transparent substrate 55a, a birefringent material layer 56 composed of a birefringent material in the second region 52 and a birefringent material layer 57 composed of a birefringent material in the third region 53. Here, the X-, Y-, and Z-directions are defined to be the same as those shown in FIGS. 4A and 4B, also in FIG. 9B. Further, in this example, although a schematic sectional view of the depolarization element 50b is not shown, it is assumed that the same components as the first region 51, the second region 52, and the third region 53 of the depolarization element 50a are employed apart from their arrangement.

First, the configuration shown in FIG. 9A is described below. In the depolarization element 50a according to the configuration shown in FIG. 9A, a birefringent material layer 56 in the second region 52 and a birefringent material layer 57 in the third region 53 are provided on the transparent substrate 55a. Further, an alignment film (not shown) may be provided between the transparent substrate 55a and the birefringent material layers 56 and 57. Then, the birefringent materials constituting these layers are composed of an identical material and have the same thickness. However, in the X-Y plane, for example, it is assumed that the direction of the slow axis of the birefringent material layer 56 is uniform in the direction of −30 degrees or 60 degrees relative to the X-axis and that the direction of the slow axis of the birefringent material layer 57 is uniform in the direction of 30 degrees or −60 degrees relative to the X-axis. At that time, it is preferable that the thickness d of the birefringent material layers 56 and 57 is set to be a value approximately equal to (2m−1)λ/(2×Δn) where m is a natural number, so that the birefringent material layers 56 and 57 serve as ½-wave plates. Further, for example, a configuration may be employed that a filling material layer and a transparent substrate (not shown) are provided on the birefringent material layers 56 and 57 so that these components are integrated together. Further, m=1 is preferable by a reason similar to that described above. Here, in FIG. 9A, the polarization states of the light transmitted through the second region 52 and the third region 53 have been, for convenience, shown as linearly polarized light beams different from each other.

Then, when the incident light is linearly polarized in the Y-direction, the light incident onto the first region 51 is transmitted without a change in the polarization state and hence remains in the intact form of the linearly polarized light 51a in the Y-direction. On the other hand, the light incident onto the second region 52 is transmitted through the birefringent material layer 56 having the function of a ½-wave plate, and thereby converted into linearly polarized light 52a at an angle of 30 degrees relative to the X-axis. Further, the light incident onto the third region 53 is transmitted through the birefringent material layer 57 having the function of a ½-wave plate, and thereby converted into linearly polarized light 53a at an angle of −30 degrees relative to the X-axis. By virtue of this, the light incident onto the depolarization element 50a is transmitted in such polarization states that linearly polarized light beams transmitted through mutually adjacent regions are at an angle of 120 degrees relative to each other. This reduces a speckle noise.

Further, it has been assumed that the first region 51 does not have a birefringent material layer. However, employable configurations are not limited to this. For example, in a case that the slow axis is not twisted, even when the first region 51 also has a birefringent material layer 56 while the thickness of the first region 51 is λ/(Δn) and the thickness of the second region 52 is λ/(2×Δn), the polarization state of the light transmitted through each region becomes as shown in FIG. 8C. Further, employed configurations are not limited to such a configuration that the birefringent material layer 56 of the second region 52 and the birefringent material layer 57 of the third region 53 have the function of a ½-wave plate, and may be a configuration that the function of a polarization rotating element may be provided in which the slow axes are aligned in a twisted manner by +30 degrees and −30 degrees in the thickness direction about the optical axis.

Next, the configuration shown in FIG. 9B is described that realizes the polarization states shown in FIG. 8D. In the depolarization element 50a according to the configuration shown in FIG. 9B, a birefringent material layer 58 in the second region 52 and a birefringent material layer 59 in the third region 53 are provided on the transparent substrate 55a. Then, these layers are composed of the same birefringent material and the direction of the slow axis in the X-Y plane is identical in the same direction of, for example, 45 degrees relative to the X-axis direction. However, their thicknesses are different from each other. Further, an alignment film (not shown) may be provided between the transparent substrate 55a and the birefringent material layers 58 and 59. Then, it is preferable that the thicknesses of these birefringent material layers are adjusted so that the polarization states of the first elliptically polarized light 52b and the second elliptically polarized light 53b are adjusted such that when the individual Stokes vectors of the light transmitted through these regions are composed with each other in the Poincare sphere shown in FIG. 3, approximate zero is obtained. Further, for example, the depolarization elements 50a and 50b may have a configuration that a filling material layer and a transparent substrate are provided on the birefringent material layers 58 and 59 so that these components are integrated together. Here, in FIG. 9B, the polarization states of the light transmitted through the second region 52 and the third region 53 have been, for convenience, shown as elliptically polarized light beams different from each other.

Further, when the depolarization element 50a according to the present embodiment is employed as the depolarization element 20 of the projection type display apparatus 10b, it is sufficient that the rocking control section 21 oscillates in a direction different from the longitudinal direction of the unit region 54a and, in particular, it is preferable to oscillate in a direction perpendicular to the longitudinal direction. Further, when the depolarization element 50b is employed as the depolarization element 20 of the projection type display apparatus 10b, it is preferable that the rocking control section 21 oscillates at least in two dimensions that intersect the optical axis. At that time, the oscillation may be controlled such that rotational oscillation is performed or its orbit forms a circle. As such, when the rocking control section 21 performs oscillation control, the polarization state of the transmitted light is varied not only spatially but also time-dependently. This reduces a speckle noise remarkably.

(Fourth Embodiment of Depolarization Element Employed in Projection Type Display Apparatus)

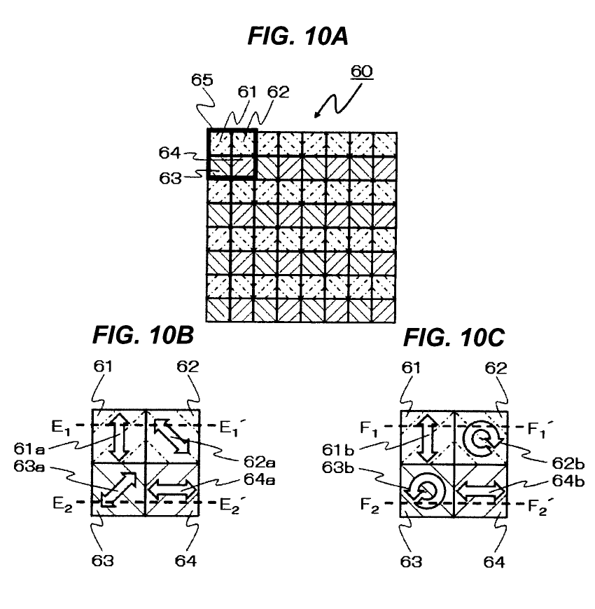

The third embodiment of the depolarization element given above has been described for a case that each unit region is constructed from a first region, a second region, and a third region whose polarization states of the transmitted light are different from each other. The fourth embodiment of the depolarization element is described for a depolarization element whose unit region is constructed from a first region, a second region, a third region, and a fourth region. FIG. 10A is a schematic plan view of a depolarization element 60 according to the present embodiment, which is constructed from a first region 61, a second region 62, a third region 63, and a fourth region 64. Further, the light transmitted through the first region 61 has a uniform polarization state, the light transmitted through the second region 62 has a uniform polarization state, the light transmitted through the third region 63 has a uniform polarization state, and the light transmitted through the fourth region 64 has a uniform polarization state. However, the polarization states of the transmitted light through these regions are different from each other.

In the depolarization element 60 shown in FIG. 10A, a plurality (preferably 5 to 50 by the same reason as that in the first embodiment of the depolarization element) of square unit regions 65 each of which is constructed from a first region 61, a second region 62, a third region 63, and a fourth region 64 each having a square shape are arranged successively in two dimensions. Here, the shape of each of the four regions is not limited to a square, and may be a rectangle or the like. FIGS. 10B and 10C are schematic plan views showing the unit region 65 alone in an expanded manner. Specifically, these views show exemplary combinations of the polarization states of the light transmitted through the first region 61, the second region 62, the third region 63, and the fourth region 64.

Here, specifically, FIG. 10B shows the situation of the first linearly polarized light 61a in the first polarization direction, the second linearly polarized light 62a in the second polarization direction, the third linearly polarized light 63a in the third polarization direction, and the fourth linearly polarized light 64a in the fourth polarization direction. Further, employable combinations are not limited to a combination of linearly polarized light beams and may be, as shown in FIG. 10C, a combination between first linearly polarized light 61b in a first polarization direction, first circularly polarized light 62b in a second polarization direction, second circularly polarized light 63b in a third polarization direction, and second linearly polarized light 64b in a fourth polarization direction. Further, for example, elliptically polarized light may be included as long as these Stokes vectors expressing the polarization states of the light are in a relation of canceling out with each other.

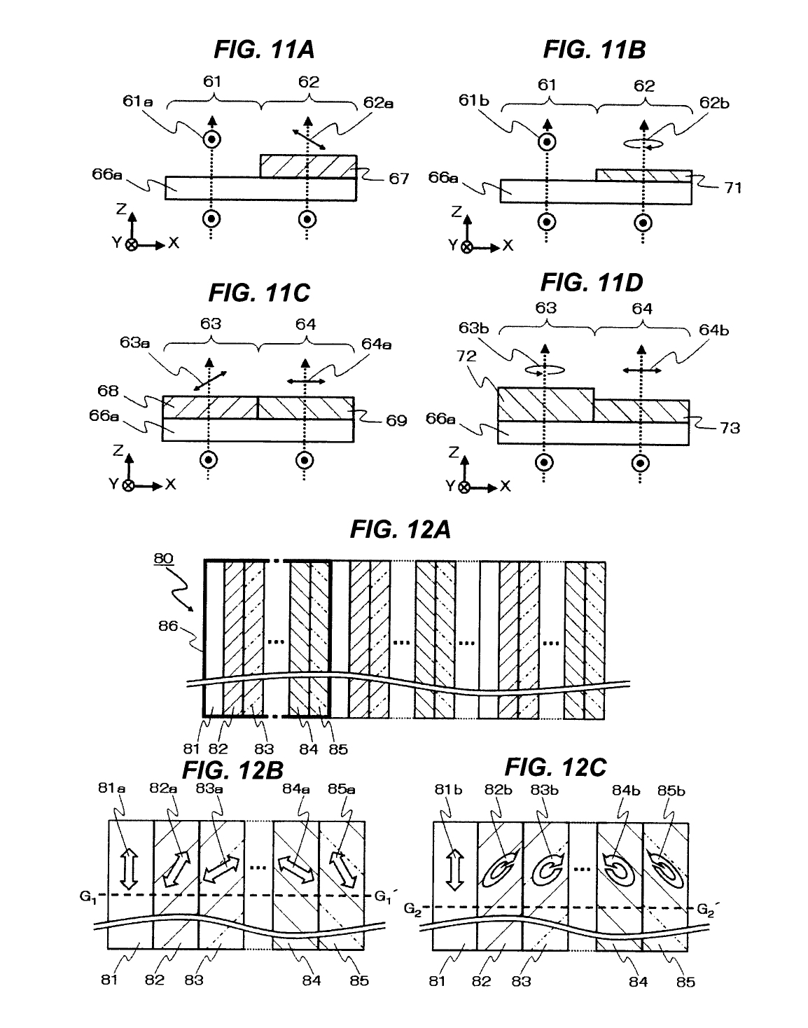

Next, detailed configurations of the unit region 65 for transmitting the light of individual polarization states shown in FIGS. 10B and 100 are described below. First, FIGS. 11A and 11B show examples of schematic sectional views taken along lines E₁-E₁′ and E₂-E₂′ respectively in FIG. 10B. The depolarization element 60 has a birefringent material layer 67, a birefringent material layer 68, and a birefringent material layer 69 composed of a birefringent material on a transparent substrate 66a. Further, an alignment film (not shown) may be provided between the transparent substrate 66a and the birefringent material layers 67, 68, and 69. Then, the birefringent materials constituting these layers are composed of an identical material and have the same thickness. Then, in the X-Y plane, for example, it is assumed that the direction of the slow axis of the birefringent material layer 67 is uniform in the direction of 22.5 degrees or −67.5 degrees relative to the X-axis, the direction of the slow axis of the birefringent material layer 68 is uniform in the direction of −22.5 degrees or 67.5 degrees relative to the X-axis, and the direction of the slow axis of the birefringent material layer 69 is uniform in the direction of 45 degrees or −45 degrees relative to the X-axis. Here, the X-, Y-, and Z-directions are defined to be the same as those shown in FIGS. 4A and 4B, also in FIGS. 11C and 11D.

At that time, it is preferable that the thickness d of the birefringent material layers 67, 68, and 69 is set to be a value approximately equal to (2m−1)λ/(2×Δn) where m is a natural number, so that the birefringent material layers 67, 68, and 69 serve as ½-wave plates. Further, for example, a configuration may be employed that a filling material layer and a transparent substrate are provided on the birefringent material layers 67, 68, and 69 so that these components are integrated together. Further, m=1 is preferable by a reason similar to that described above. Here, in FIGS. 11A and 11B, the polarization states of the light transmitted through the second region 62 and the third region 63 have been, for convenience, shown as linearly polarized light beams different from each other.

Then, when the incident light is linearly polarized in the Y-direction, the light incident onto the first region 61 is transmitted without a change in the polarization state and hence remains in the intact form of the linearly polarized light 61a in the Y-direction. On the other hand, the light incident onto the second region 62 is transmitted through the birefringent material layer 67 having the function of a ½-wave plate, and thereby converted into linearly polarized light 62a at an angle of −45 degrees relative to the X-axis. The light incident onto the third region 63 is transmitted through the birefringent material layer 68 having the function of a ½-wave plate, and thereby converted into linearly polarized light 63a at an angle of 45 degrees relative to the X-axis. Further, the light incident onto the fourth region 64 is transmitted through the birefringent material layer 69 having the function of a ½-wave plate, and thereby converted into linearly polarized light 64a in the X-direction. By virtue of this, the light incident onto the depolarization element 60 is transmitted in the form of linearly polarized light beams transmitted through mutually adjacent regions are at an angle of 45 degrees relative to each other. This reduces a speckle noise.

Further, at that time, the Stokes parameter S(1) of the first linearly polarized light 61a is S(1)=(−1, 0, 0), the Stokes parameter S(2) of the second linearly polarized light 62a is S(2)=(0, −1, 0), the Stokes parameter S(3) of the third linearly polarized light 63a is S(3)=(0, 1, 0), and the Stokes parameter S(4) of the fourth linearly polarized light 64a is S(4)=(1, 0, 0). According to these Stokes parameters by using the Poincare sphere shown in FIG. 3, when the Stokes vectors of the light transmitted through the individual regions are composed with each other, a relation of approximate zero is obtained.

Next, FIGS. 11C and 11D show examples of schematic sectional views taken along lines F₁-F₁′ and F₂-F₂′ respectively in FIG. 10C. The depolarization element 60 has a birefringent material layer 71, a birefringent material layer 72, and a birefringent material layer 73 composed of a birefringent material on the transparent substrate 66a. Further, an alignment film (not shown) may be provided between the transparent substrate 66a and the birefringent material layers 71, 72, and 73. Then, for example, it is assumed that the same birefringent material is employed for constructing these components and the direction of the slow axis in the X-Y plane is also identical and uniform in the direction of 45 degrees relative to the X-axis but that their thicknesses are different from each other.

Specifically, when m, p, and q are natural numbers, it is preferable that the thickness d₂ of the birefringent material layer 71 is set to be a value approximately equal to (4m−3)λ/(4×Δn), that the thickness d₃ of the birefringent material layer 72 is set to be a value approximately equal to (4p−1)λ/(4×Δn) so as to serve as a ¼-wave plate, and that the thickness d₃ of the birefringent material layer 72 is set to be a value approximately equal to (2q−1)λ/(2×Δn) so as to serve as a ½-wave plate. Further, for example, a configuration may be employed that a filling material layer is filled onto the birefringent material layers 71, 72, and 73 so that flattening is achieved and then these components are integrated together with a transparent substrate. Further, also in this case, m=1, p=1, and q=1 are preferable by a reason similar to that in the first embodiment of the depolarization element (according to FIG. 5B).

Then, when the incident light is linearly polarized in the Y-direction, the light incident onto the first region 61 is transmitted without a change in the polarization state and hence remains in the intact form of the linearly polarized light 61b in the Y-direction. On the other hand, the light incident onto the second region 62 is transmitted through the birefringent material layer 71 having the function of a ¼-wave plate, and thereby converted into right-handed circularly polarized light 62b. The light incident onto the third region 63 is transmitted through the birefringent material layer 72 having the function of a ¼-wave plate, and thereby converted into left-handed circularly polarized light 63b. Further, the light incident onto the fourth region 64 is transmitted through the birefringent material layer 73 having the function of a ½-wave plate, and thereby converted into linearly polarized light 64b in the X-direction. By virtue of this, the light incident onto the depolarization element 60 is transmitted in such a manner that light beams transmitted through mutually adjacent regions are different from each other. This reduces a speckle noise.

Further, at that time, the Stokes parameter S(1) of the first linearly polarized light 61b is S(1)=(−1, 0, 0), the Stokes parameter S(2) of the first circularly polarized light 62b is S(2)=(0, 0, 1), the Stokes parameter S(3) of the second circularly polarized light 63b is S(3)=(0, 0, −1), and the Stokes parameter S(4) of the second linearly polarized light 64b is S(4)=(1, 0, 0). According to these Stokes parameters by using the Poincare sphere shown in FIG. 3, when the Stokes vectors of the light transmitted through the individual regions are composed with each other, a relation of approximate zero is obtained.

As such, description of situations that light beams in four mutually different polarization states are transmitted through the unit region 65 has been given for a combination of linearly polarized light beams and for a combination of linearly polarized light beams and circularly polarized light beams. However, employable combinations are not limited to these. That is, the combination of transmitted light beams may include elliptically polarized light beams as long as when the Stokes vectors of the light beams of the four mutually different polarization states are composed, approximate zero is obtained.

Further, when the depolarization element 60 according to the present embodiment is employed as the depolarization element 20 of the projection type display apparatus 10b, it is preferable that the rocking control section 21 oscillates at least in two dimensions that intersect the optical axis. At that time, the oscillation may be controlled such that rotational oscillation is performed or its orbit forms a circle. As such, when the rocking control section 21 performs oscillation control, the polarization state of the transmitted light is varied not only spatially but also time-dependently. This reduces a speckle noise remarkably.

(Fifth Embodiment of Depolarization Element Employed in Projection Type Display Apparatus)

The fourth embodiment of the depolarization element given above has been described for a case that each unit region is constructed from four regions whose polarization states of the transmitted light are different from each other. The fifth embodiment of the depolarization element is described for a depolarization element whose unit region is constructed from a first region, a second region, a third region, . . . , an Nth region (N is an integer ≧5). FIG. 12A is a schematic plan view of a depolarization element 80 according to the present embodiment. The unit region 86 is constructed such that the first region 81, the second region 82, the third region 83, . . . , the (N−1)th region 84, the Nth region 85 are aligned in this order. Further, the light transmitted through each of the first to the Nth regions has a uniform polarization state. However, the polarization states of the transmitted light through these regions are different from each other.

In the depolarization element 80, unit regions 86 each composed of a first region 81 to an Nth region 85 are arranged successively in a particular direction. Specifically, each of the first region 81 to the Nth region 85 has a rectangular shape, and a plurality (preferably 5 to 50 by the same reason as that in the first embodiment of the depolarization element) of unit regions 86 are arranged in the lateral direction of the rectangle. Here, it is sufficient that the unit region 86 has a shape having a longitudinal direction and a lateral direction and elongated in one direction. That is, the unit region 86 may be not a rectangle and may be, for example, a parallelogram, a trapezoid, other polygons, and a shape having a curved surface. The unit regions are arranged such that a plurality of these are aligned in lateral direction. FIGS. 12B and 12C are schematic plan views in which a single unit region 86 is shown in an expanded manner. Specifically, FIG. 12B shows the situation of first linearly polarized light 81a in a first polarization direction, second linearly polarized light 82a in a second polarization direction, third linearly polarized light 83a in a third polarization direction, . . . , (N−1)th linearly polarized light 84a in an (N−1)th polarization direction, and Nth linearly polarized light 85a in an Nth polarization direction.

Further, employable combinations are not limited to a combination of linearly polarized light beams and may be, for example, as shown in FIG. 12C, a combination between (first) linearly polarized light 81b in a first polarization direction, first elliptically polarized light 82b in a second polarization direction, second elliptically polarized light 83b in a third polarization direction, . . . , (N−2) th elliptically polarized light 84b in an (N−1)th polarization direction, and (N−1)th elliptically polarized light 85b in an Nth polarization direction. Also in the present embodiment, for example, a combination of polarization states other than this may be employed as long as these Stokes vectors expressing the polarization states of the light are in a relation of canceling out with each other. Further, in the depolarization element 80, it has been assumed that each region constituting the unit region 86 has a rectangular shape. However, employable configurations are not limited to this and may be such that, for example, square regions are aligned in two dimensions so as to constitute a unit region.

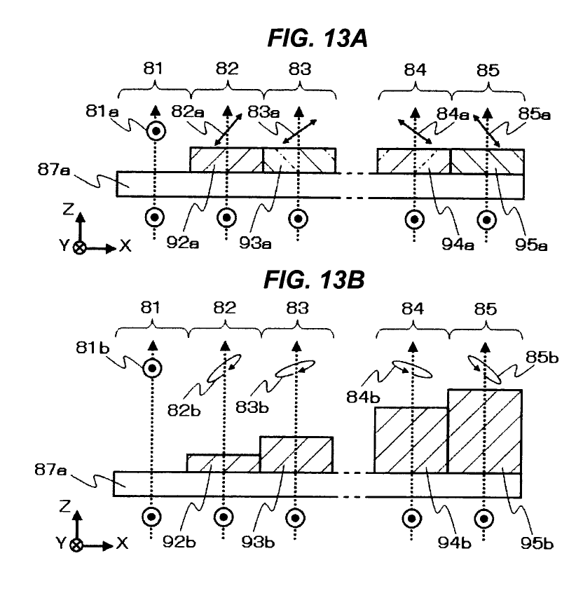

Next, detailed configurations of the unit region 86 for transmitting the light of individual polarization states shown in FIGS. 12B and 12C are described below. First, the configuration shown in FIG. 13A is described below. Further, FIG. 13A shows an example of a schematic sectional view taken along line G₁-G₁′ in FIG. 12B. The depolarization element 80 has, on a transparent substrate 87a, a birefringent material layer 92a composed of a birefringent material in the second region 82 and a birefringent material layer 93a composed of a birefringent material in the third region 83. Further, the depolarization element 80 has a birefringent material layer 94a composed of a birefringent material in the (N−1)th region 84 and a birefringent material layer 95a composed of a birefringent material in the Nth region 85. Further, an alignment film (not shown) may be provided between the transparent substrate 87a and the birefringent material layers 92a, 93a, . . . , 94a, and 95a. Here, the X-, Y-, and Z-directions are defined to be the same as those shown in FIGS. 4A and 4B, also in FIG. 13B.

Then, the birefringent materials constituting these layers are composed of an identical material and have the same thickness. However, in the X-Y plane, for example, it is assumed that the direction of the slow axis of the birefringent material layer 92a, the direction of the slow axis of the birefringent material layer 93a, . . . , the direction of the slow axis of the birefringent material layer 94a, and the direction of the slow axis of the birefringent material layer 95a are individually uniform but distributed in angular directions at equal intervals. At that time, it is preferable that the thickness d of the birefringent material layers 92a, 93a, . . . , 94a, and 95a is set to be a value approximately equal to (2m−1)λ/(2×Δn) where m is a natural number, so that the birefringent material layers 92a, 93a, . . . , 94a, and 95a serve as ½-wave plates. Further, for example, a configuration may be employed that a filling material layer and a transparent substrate (not shown) are provided on the birefringent material layers 92a, 93a, . . . , 94a, and 95a so that these components are integrated together. Further, m=1 is preferable by a reason similar to that described above. Here, in FIG. 13A, the polarization states of the light transmitted through the second region 82, the third region 83, . . . , the (N−1)th region 84, and the Nth region 85 have been, for convenience, shown as linearly polarized light beams different from each other.

Then, when the incident light is linearly polarized in the Y-direction, the light incident onto the first region 81 is transmitted without a change in the polarization state and hence remains in the intact form of the linearly polarized light 81a in the Y-direction. On the other hand, the light incident onto the second region 82 is transmitted through the birefringent material layer 92a having the function of a ½-wave plate, and thereby converted into linearly polarized light 82a at an angle of (180/N) degrees relative to the Y-axis. Further, the light incident onto the third region 83 is transmitted through the birefringent material layer 93a having the function of a ½-wave plate, and thereby converted into linearly polarized light 83a at an angle of 2×(180/N) degrees relative to the Y-axis. Further, the light incident onto the (N−1)th region 84 is transmitted through the birefringent material layer 94a having the function of a ½-wave plate, and thereby converted into linearly polarized light 84a at an angle of (N−2)×(180/N) degrees relative to the Y-axis. Further, the light incident onto the Nth region 85 is transmitted through the birefringent material layer 95a having the function of a ½-wave plate, and thereby converted into linearly polarized light 85a at an angle of (N−1)×(180/N) degrees relative to the Y-axis. By virtue of this, the light incident onto the depolarization element 80 is transmitted in such polarization states that linearly polarized light beams transmitted through mutually adjacent regions are at an angle of (180/N) degrees relative to each other. This reduces a speckle noise.

Further, employable configurations of the birefringent material layer 92a of the second region 82, the birefringent material layer 93a of the third region 83, . . . , the birefringent material layer 94a of the (N−1)th region 84, and the birefringent material layer 95a of the Nth region 85 are not limited to that the function of a ½-wave plate is provided, and may be such that the slow axis is aligned in a twisted manner in the thickness direction degrees about the optical axis direction. At that time, the twist angle of each region is (180/N) degrees for the birefringent material layer 92a of the second region 82, 2×(180/N) degrees for the birefringent material layer 93a of the third region 83, . . . , (N−2)×(180/N) degrees for the birefringent material layer 94a of the (N−1)th region 84, and (N−1)×(180/N) degrees for the birefringent material layer 95a of the Nth region 85. Further, it has been assumed that the first region 81 does not have a birefringent material layer. However, employable configurations are not limited to this. For example, the slow axis may be not twisted, and a birefringent material layer may be provided also in the first region 81. Then, the thickness of the birefringent material layer of the first region 81 may be λ/(Δn), and the thickness of the second region 82 may be λ/(2×Δn). Alternatively, for example, when the optic axis of the birefringent material layer of the first region 81 is set to agree with the Y-axis direction, the polarization state of the light transmitted through each region becomes as shown in FIG. 12B.

Next, the configuration shown in FIG. 13B is described that realizes the polarization states shown in FIG. 12C. The depolarization element 80 according to the configuration shown in FIG. 13B has a birefringent material layer 92b in the second region 82, a birefringent material layer 93b in the third region 83, . . . , a birefringent material layer 94b in the (N−1)th region 84, and a birefringent material layer 95b in the Nth region 85, on a transparent substrate 87a. The birefringent materials constituting these layers are composed of an identical material. Further, the direction of the slow axis is identical in the direction of, for example, 45 degrees relative to the X-axis in the X-Y plane. However, it is assumed that these layers have mutually different thicknesses. Further, an alignment film (not shown) may be provided between the transparent substrate 87a and the birefringent material layers 92b, 93b, . . . , 94b, and 95b.

Then, it is preferable that the thicknesses of these birefringent material layers are adjusted so that the polarization states of, for example, the first elliptically polarized light 82b, the second elliptically polarized light 83b, . . . , the (N−2)th elliptically polarized light 84b, and the (N−1)th elliptically polarized light 85b are adjusted such that when the individual Stokes vectors of the light transmitted through these regions are composed with each other in the Poincare sphere shown in FIG. 3, approximate zero is obtained. Further, for example, the depolarization element 80 may have a configuration that a filling material layer and a transparent substrate are provided on the birefringent material layers 92a, 93a, . . . , 94a, and 95a so that these components are integrated together. Here, in FIG. 13B, the polarization states of the light transmitted through the second region 82, the third region 83, the (N−1)th region 84, and the Nth region 85 have been, for convenience, shown as elliptically polarized light beams different from each other.

Further, when the depolarization element 80 according to the present embodiment is employed as the depolarization element 20 of the projection type display apparatus 10b, it is sufficient that the rocking control section 21 oscillates in a direction different from the longitudinal direction of the unit region 86 and, in particular, it is preferable to oscillate in a direction perpendicular to the longitudinal direction. As such, when the rocking control section 21 performs oscillation control, the polarization state of the transmitted light is varied not only spatially but also time-dependently. This reduces a speckle noise remarkably.

(Sixth Embodiment of Depolarization Element Employed in Projection Type Display Apparatus)

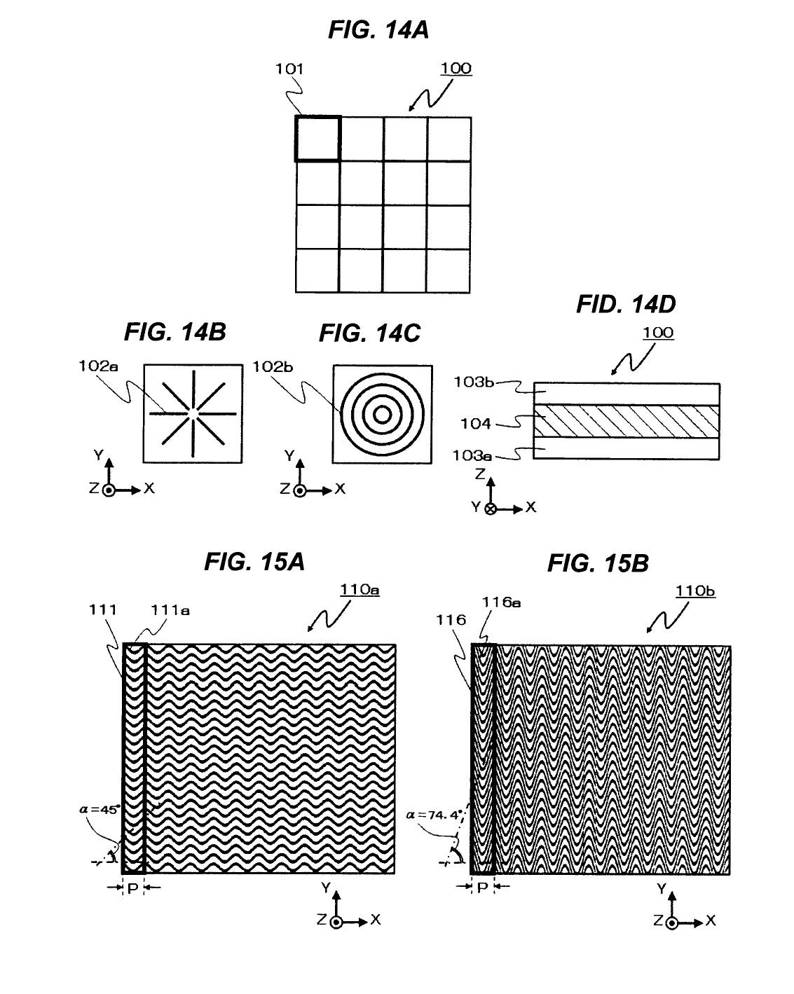

In the configuration of each depolarization element employed in a projection type display apparatus described above, unit regions have been provided. Then, in each of the plurality of regions constituting each unit region, light transmitted through the region had a uniform polarization state. Also in the sixth embodiment of the depolarization element, unit regions are provided. However, in each unit region, the polarization state of the transmitted light varies continuously. FIG. 14A is a schematic plan view of a depolarization element 100 according to the present embodiment, in which a plurality (preferably 5 to 50 by the same reason as that in the first embodiment of the depolarization element) of square unit regions 101 are arranged in two dimensions successively. Further, in addition to the arrangement of the square unit regions 101 shown in FIG. 14A, unit regions each having the shape of a triangle, a polygon, or the like may be arranged.

FIGS. 14B and 14C are schematic plan views in which a unit region 101 is shown in an expanded manner. Specifically, in FIG. 14B, the optic axis 102a is provided radially from the center of the unit region 101. In FIG. 14C, the optic axis 102b is provided concentrically from the center of the unit region 101. Here, FIGS. 14B and 14C have been given for exemplary cases that the optic axis varies successively. However, employable configurations are not limited to this. In the case of FIG. 14B, for example, 12 regions may be provided at 30-degree intervals about the center of the unit region such that the optic axis is uniform in each region, so that a pseudo-radial optic axis may be formed. Further, in the case of FIG. 14C, for example, 12 regions may be provided at 30-degree intervals about the center of the unit region such that the optic axis is uniform in each region, so that a pseudo-concentric optic axis may be formed. In this case, in a strict description, the pseudo-concentric configuration is a pattern of optic axis like a regular dodecagon. In the following description, the radial or concentric configuration includes such pseudo-radial or pseudo-concentric configurations. Further, FIG. 14D is a schematic sectional view of the depolarization element 100. In the depolarization element 100, a birefringent material layer 104 having predetermined alignment is provided between a transparent substrate 103a and a transparent substrate 103b. Here, an alignment film (not shown) may be provided between the transparent substrate 103a and the birefringent material layer 104 and between the transparent substrate 103b and the birefringent material layer 104.

Further, when polymer liquid crystal is employed as the birefringent material of the birefringent material layer 104, the method of patterning the alignment direction by UV light irradiation may be employed or alternatively a groove shape may be fabricated in the transparent substrates 103a and 104b, so that desired alignment may be fabricated in this plane. Alternatively, the birefringent material layer 104 may be such that in a construction of structural birefringence fabricated in a lattice shape, the optic axis is varied periodically. Further, a photonic crystal in which a multilayer film is formed in a lattice shape so that refractive index anisotropy is realized may be employed so that the direction of optic axis may be varied periodically.

Further, when the birefringent material layer 104 is arranged between alignment films (not shown), the alignment film on the transparent substrate 103a side and the alignment film on the transparent substrate 103b side are superposed with each other such that the alignment directions in the plan view of the transparent substrates agree with each other. Then, by virtue of this configuration of the alignment films, the direction of the optic axis of the birefringent material constituting the birefringent material layer 104 is aligned in a state that no twist is present in the thickness direction. Further, the alignment film is obtained by a rubbing process of a polyimide film or the like. Instead, for example, oblique vapor deposition of SiO₂ may be performed. Preferable birefringent materials employed in the birefringent material layer 104 include liquid crystals and polymer liquid crystals. Further, when a polymer liquid crystal is employed, for example, the depolarization element 100 may have a configuration that the alignment films (not shown) on the transparent substrate 103b side and on the transparent substrate 103b side are removed.

Next, the thicknesses of the birefringent material layers are described. When light of wavelength λ is employed as incident light onto the depolarization element 100, it is preferable that the thickness d of the birefringent material layer 104 is set to be a value approximately equal to (2m−1)λ/(2×Δn) with a natural number m so as to serve as a ½-wave plate. Further, in this case, m=1 is preferable by a reason similar to that described above.

Then, when the incident light is linearly polarized in the Y-direction, the light transmitted through parts where the optic axes 102a and 102b are in the Y-axis direction or the X-axis direction is transmitted without a change in the polarization state, and hence remains in the intact form of linearly polarized light in the Y-direction. Then, the light transmitted through a part where the optic axes 102a and 102b are at an angle θ (≠0° and ≠±90°) relative to the Y-axis direction is transmitted through in the form of linearly polarized light at an angle 2θ relative to the Y-axis direction by virtue of the optical characteristics of the ½-wave plate. As such, for example, in the depolarization element 100 having the unit region of radial optic axis distribution shown in FIG. 14B or the unit region of the concentric optic axis distribution shown in FIG. 14C, the optic axis varies continuously and hence the polarization state of the transmitted linearly polarized light also varies continuously.

Further, the depolarization element according to the present embodiment has been described for exemplary cases that the optic axis in the unit region has radial or concentrically distribution. In these cases, transmitted light is linearly polarized. Then, in the Poincare sphere shown in FIG. 3, Stokes vectors along the equator of the Poincare sphere are generated and then these vectors cancel out with each other into approximate zero. Further, employable configurations of the unit region are not limited to the above-mentioned one and may be such that circularly polarized light or elliptically polarized light are included as long as when the Stokes vectors of the light transmitted through the unit region are composed with each other in the Poincare sphere shown in FIG. 3, approximate zero is obtained.

Further, when the depolarization element 100 according to the present embodiment is employed as the depolarization element 20 of the projection type display apparatus 10b, it is preferable that the rocking control section 21 oscillates at least in two dimensions that intersect the optical axis. At that time, the oscillation may be controlled such that rotational oscillation is performed or its orbit forms a circle. As such, when the rocking control section 21 performs oscillation control, the polarization state of the transmitted light is varied not only spatially but also time-dependently. This reduces a speckle noise remarkably.

(Seventh Embodiment of Depolarization Element Employed in Projection Type Display Apparatus)

In a seventh embodiment of the depolarization element, the polarization state of the light transmitted through the unit region varies continuously in a different manner from that in the sixth embodiment. FIGS. 15A and 15B are schematic plan views of depolarization elements 110a and 110b according to the present embodiment. In each depolarization element, a plurality (preferably 5 to 50 by the same reason as that in the first embodiment of the depolarization element) of rectangular unit regions 111 and 116 are arranged successively in the lateral direction of the rectangle. Further, as shown in FIGS. 15A and 15B, the unit region 111 or 116 has optic axes 111a or 116a distributed in a wave shape in the direction of the minor axis of the unit region. One period of this wave shape corresponds to the length of the shorter side of the unit region. Here, FIGS. 15A and 15B have been given for exemplary cases that the optic axis varies successively. However, employable configurations are not limited to this. For example, a pseudo-wave pattern may be employed in which the optic axes become discontinuous in a certain part. In the following description, the wave shape includes such a pseudo-wave pattern.

Further, schematic sectional views of the depolarization elements 110a and 110b are omitted. However, their structures are similar to the structure of the depolarization element 100 according to the sixth embodiment shown in FIG. 14D. That is, a birefringent material layer having the function of a ½-wave plate is provided. Then, for example, when the optic axes of the birefringent material constituting this birefringent material layer are considered in the plan view the optic axes are distributed in a wave shape.

Next, a detailed wave shape of the optic axis distribution is described below. The wave-shaped distribution may be in a pattern of a sine curve, a cosine curve, a periodic curve obtained by connecting an upward convex semicircle and a downward convex semicircle alternately, a periodic curve obtained by connecting an upward convex parabola and a downward convex alternately, and the like. Further, in a case that a part is present where the inclination of the wave is 45 degrees relative to the traveling direction of the wave, for example, relative to the X-axis direction in FIGS. 15A and 15B, when, for example, linearly polarized light in the Y-direction is incident onto the part of inclination of 45 degrees, the light is transmitted in the form of linearly polarized light in the X-direction. Further, a part where the inclination of the wave is 0 is included unavoidably. Thus, in this case, the transmitted light contains both of linearly polarized light in the X-direction and linearly polarized light in the Y-direction which are orthogonal to each other. Thus, such a configuration is preferable.

Further, when the shape of a sine curve

{P/(2π)}×sin {2π(x/P)} (1)

is adopted, the maximum inclination α of the optic axis becomes 45 degrees. Thus, the transmitted light contains linearly polarized light beams orthogonal to each other. Thus, this configuration is preferable. Further, x denotes the coordinate axis of the traveling direction of the wave, and P denotes the pitch. Here, FIG. 15A shows a depolarization element 110a having a wave-shaped distribution in which the maximum inclination α of the optic axis is 45 degrees.

Further, for the purpose of improvement of the depolarization property, such a configuration is preferable that when the Stokes vectors of the light transmitted through the unit region 111 or 116 are composed with each other in the Poincare sphere shown in FIG. 3, approximate zero is obtained. In this case, the design may be such that the sum of the component in the X-direction and the component in the Y-direction becomes approximately the same for the polarization states of the transmitted light over one period of the periodic curve. For example, when the pitch P is 1 [mm] and the amplitude coefficient of the sine curve is 0.104 [mm] or 0.569 [mm], the sum of the component in the X-direction and the component in the Y-direction becomes approximately the same for the polarization states of the transmitted light over one period of the sine curve. Here, FIG. 15B shows a depolarization element 110b employing the above-mentioned exemplary design in which a wave-shaped distribution having the maximum inclination α of the optic axis of 74.4 degrees is adopted while the pitch P is 1 [mm] and the amplitude coefficient of the sine curve is 0.569 [mm].

Further, also for the wave-shape waveform, when a design is adopted that the inclination angle of the optic axis varies at a constant ratio relative to the x-direction which is the traveling direction of the wave and that the maximum inclination cc is 45°, the sum of the component in the x-direction and the component in the y-direction becomes approximately the same for the polarization states of the transmitted light. Thus, the depolarization property is improved, and hence this configuration is preferable. In a shape according to this design, for example, it is preferable that, where m is an integer,

(P/π)ln|cos (πx/P−mπ)|−(P/π)ln|cos (π/4)| (2a)
for −P/4+mP≦x≦P/4+mP, and

−(P/π)ln|cos {πx/P−(1+2m)π/2}|+(P/π)ln|cos (π/4)| (2b)
for P/4+mP≦x≦3P/4+mP

Further, when the depolarization element 110a or 110b according to the present embodiment is employed in the depolarization element 20 of the projection type display apparatus 10b, it is preferable that the rocking control section 21 is oscillated at least in one dimension in a plane intersecting the optical axis. It is more preferable that the oscillation is in the period direction. Further, it is preferable that the control is performed in two dimensions such that rotational oscillation is performed or alternatively the orbit forms a circle. As such, when the rocking control section 21 performs oscillation control, the polarization state of the transmitted light is varied not only spatially but also time-dependently. This reduces a speckle noise remarkably.

Further, the depolarization elements according to the present embodiment had a wave-shaped periodic distribution in which the optic axis varies continuously. However, even when the wave-shaped distribution becomes discrete in a small part, an equivalent effect is obtained as long as a depolarization property at a certain level is achieved.

### EXAMPLES

### Example 1

In the present example, according to the second embodiment of the depolarization element, a depolarization element is fabricated in which unit regions 43 each composed of a first region 41 and a second region 42 are arranged in a checkered pattern. First, an antireflection film is formed on one surface of a transparent substrate composed of quartz glass. Then, polyimide is applied to a surface opposite to the antireflection film side, and then baked. Then, rubbing processing is performed linearly in the same direction so that an alignment film is obtained.

Then, a polymer liquid crystal layer having a thickness of approximately 6.6 μm is formed on the alignment film so that a polymer liquid crystal layer is obtained that has a uniform thickness and has the optic axis aligned to the rubbing direction of the alignment film. Further, the polymer liquid crystal is a material having an ordinary light refractive index n₀ of 1.50 and an extraordinary light refractive index nₑ of 1.54 to light having a wavelength of 532 nm. After that, by virtue of a photolithography process and a dry etching process, the polymer liquid crystal layer is removed in regions of 0.5 mm×0.5 mm square arranged regularly at constant intervals, so that patterning is achieved such that regions where the polymer liquid crystal remains and regions where the polymer liquid crystal has been removed form a checkered pattern. Here, each of the regions where the polymer liquid crystal remains and the regions where the polymer liquid crystal has been removed has the shape of a square of 0.5 mm×0.5 mm. As a result, a pattern is obtained in which each unit region is composed of a square checkered pattern of a size of 1 mm×1 mm and a plurality of the unit regions are arranged in a matrix of 13×11.

Next, isotropic optical material is filled in the unevenness formed by patterning of the layer of the polymer liquid crystal, and then glued to another quartz glass substrate so that a depolarization element is obtained. Then, linearly polarized light having a wavelength of 532 nm is projected onto the fabricated depolarization element in an approximately perpendicular direction relative to the quartz glass substrate surface. At that time, the depolarization element is arranged such that the polarization direction of the incident linearly polarized light is located at an angle of 45 degrees relative to the alignment direction of the polymer liquid crystal.

As such, when the linearly polarized light having a wavelength of 532 nm is projected, the light transmitted through the region having the polymer liquid crystal is converted into linearly polarized light whose polarization direction is orthogonal to that of the incident linearly polarized light. On the other hand, the light transmitted through the region where the polymer liquid crystal has been removed is transmitted in the intact form of the incident linearly polarized light. As a result, light beams transmitted through mutually adjacent regions have polarization directions orthogonal to each other. Thus, when a depolarization element is arranged on the optical path between the laser light source and the projection lens of the projection type display apparatus, a speckle noise caused by the interference of the laser light is reduced.

### Example 2

Similarly to Example 1, also in the present examples, according to the second embodiment of the depolarization element, a depolarization element is fabricated in which unit regions 43 each composed of a first region 41 and a second region 42 are arranged in a checkered pattern but a configuration different from Example 1 is realized. First, the process of forming polyimide on a transparent substrate composed of quartz glass is the same as that in Example 1. Then, rubbing processing is performed on the surface of the polyimide linearly in a reference direction. After that, a mask in which regions of 0.5 mm×0.5 mm are opened in a checkered pattern is placed, and then rubbing is performed in the direction of 45 degrees relative to the reference direction in the first rubbing. By virtue of this, an alignment film is obtained that has two kinds of regions where the rubbing direction is in the direction of 45 degrees or 0 degree on the surface of the polyimide.

Then, a polymer liquid crystal layer having a thickness of approximately 6.6 μm is formed on the alignment film so that a polymer liquid crystal layer is obtained that has a uniform thickness and has the optic axis aligned to the rubbing direction of the alignment film. The layer of this polymer liquid crystal is patterned such that the regions where the direction of optic axis is at 0 degrees and the regions where the direction of optic axis is at 45 degrees form a checkered pattern. This polymer liquid crystal is composed of the same material as that in Example 1. As a result, a depolarization element is obtained that has a pattern in which each unit region is composed of a square checkered pattern of a size of 1 mm×1 mm and a plurality of the unit regions are arranged in a matrix of 13×11.

Then, linearly polarized light having a wavelength of 532 nm is projected onto the fabricated depolarization element in an approximately perpendicular direction relative to the quartz glass substrate surface. At that time, the depolarization element is arranged such that the polarization direction of the incident linearly polarized light agrees with any one of the optic axes, that is, with the direction of 0 degrees or 45 degrees. As such, when the linearly polarized light having a wavelength of 532 nm is projected, the light transmitted through one region is converted into linearly polarized light whose polarization direction is orthogonal to that of the incident linearly polarized light. In contrast, the light transmitted through the other region is transmitted in the intact form of the incident linearly polarized light. As a result, light beams transmitted through mutually adjacent regions have polarization directions orthogonal to each other. Thus, when a depolarization element is arranged on the optical path between the laser light source and the projection lens of the projection type display apparatus, a speckle noise caused by the interference of the laser light is reduced.

As described above, the present invention provides a projection type display apparatus in which when a light source having coherence is employed, an effect of stably reducing a speckle noise regardless of the position of projection is obtained.

What is claimed is:

1. A projection type display apparatus comprising:
a light source section including at least one light source configured to emit coherent light;
an image light generating section configured to modulate the light emitted from the light source section so as to generate image light;
a projection section configured to project the image light; and
a depolarization element configured to transmit the incident light in a state that a polarization state of at least a part of the light is changed, the depolarization being provided on an optical path of the light emitted from the light source section, wherein
a plurality of unit regions having a particular shape are aligned in the depolarization element.

2. The projection type display apparatus according to claim 1, wherein
a composition of a plurality of Stokes vectors corresponds to a plurality of polarization states of the light transmitted through the unit region is approximately 0.

3. The projection type display apparatus according to claim 2, wherein:
the unit region is composed of a first region and a second region; and
light transmitted through the first region and has a first polarization direction and light transmitted through the second region and has a second polarization direction are orthogonal to each other.

4. The projection type display apparatus according to claim 3, wherein:
the first region and the second region are regions having a longitudinal direction and a lateral direction and elongated in one direction, and are aligned in the lateral direction; and
the unit regions are aligned in the lateral direction.

5. The projection type display apparatus according to claim 3, wherein
the unit region is constructed such that two of the first regions and two of the second regions are arranged in a checkered pattern; and
a plurality of the unit regions are aligned in two dimensions.

6. The projection type display apparatus according to claim 3, wherein
the light having the first polarization direction and the light having the second polarization direction are linearly polarized.

7. The projection type display apparatus according to claim 3, wherein
the light having the first polarization direction and the light having the second polarization direction are circularly polarized.

8. The projection type display apparatus according to claim 1, wherein:
the unit region includes a first region, a second region, and a third region; and
each of the first region, the second region, and the third region transmits light of a polarization state different from each other.

9. The projection type display apparatus according to claim 8, wherein:
the first region, the second region, and the third region are regions having a longitudinal direction and a lateral direction and elongated in one direction, and are aligned in the lateral direction in this order; and
the unit regions are aligned in the lateral direction.

10. The projection type display apparatus according to claim 8, wherein:
the unit region is constructed from one or two combinations of the first region, the second region, and the third region aligned in two dimensions including mutually adjacent parts; and
a plurality of the unit regions are aligned in two dimensions.

11. The projection type display apparatus according to claim 1, wherein:
the unit region includes a first region, a second region, a third region, and a fourth region; and
each of the first region, the second region, the third region, and the fourth region transmits light of a polarization state different from each other.

12. The projection type display apparatus according to claim 11, wherein:
the first region, the second region, the third region, and the fourth region are square regions and aligned in two dimensions; and
a plurality of the unit regions are aligned in two dimensions.

13. The projection type display apparatus according to claim 1, wherein:
the unit region includes N regions (N is an integer ≧5); and
each of the N regions transmits light of a polarization state different from each other.

14. The projection type display apparatus according to claim 13, wherein:
the N regions are regions having a longitudinal direction and a lateral direction and elongated in one direction, and are aligned in the lateral direction; and the unit regions are aligned in the lateral direction.

15. The projection type display apparatus according to claim 1, wherein
the depolarization element has a birefringent material layer composed of a birefringent material on a transparent substrate.

16. The projection type display apparatus according to claim 1, wherein:
the depolarization element has a birefringent material layer on a transparent substrate and in the unit region, the optic axis of the birefringent material layer extends radially from the center of the unit region; and
a plurality of the unit regions are aligned in two dimensions.

17. The projection type display apparatus according to claim 1, wherein:
the depolarization element has a birefringent material layer on a transparent substrate and in the unit region, the optic axis of the birefringent material layer extends concentrically about the center of the unit region; and
a plurality of the unit regions are aligned in two dimensions.

18. The projection type display apparatus according to claim 1, wherein:
the depolarization element has a birefringent material layer on the transparent substrate;
the unit region is a region having a longitudinal direction and a lateral direction and elongated in one direction, and the optic axis of the birefringent material layer has a shape of waves whose traveling direction is in the lateral direction; and
the unit regions are aligned in the lateral direction.

19. The projection type display apparatus according to claim 18, wherein
the maximum inclination of the optic axis forming the wave shape is 45 degrees or greater relative to the traveling direction.

20. The projection type display apparatus according to claim 18, wherein
the inclination angle of the optic axis forming the wave shape varies uniformly relative to the traveling direction.

21. The projection type display apparatus according to claim 16, wherein
the birefringent material layer has a function of a ½-wave plate so as to impart a phase difference corresponding to this to the incident light.

22. The projection type display apparatus according to claim 17, wherein
the birefringent material layer has a function of a ½-wave plate so as to impart a phase difference corresponding to this to the incident light.

23. The projection type display apparatus according to claim 18, wherein
the birefringent material layer has a function of a ½-wave plate so as to impart a phase difference corresponding to this to the incident light.

24. The projection type display apparatus according to claim 16, wherein
the birefringent material layer includes a birefringent material.

25. The projection type display apparatus according to claim 17, wherein
the birefringent material layer includes a birefringent material.

26. The projection type display apparatus according to claim 18, wherein
the birefringent material layer includes a birefringent material.

27. The projection type display apparatus according to claim 1, wherein
the light incident onto the depolarization element is linearly polarized.

28. The projection type display apparatus according to claim 1, further comprising
a rocking control section configured to oscillate the depolarization element.
